(19) United States
(12) Patent Application Publication
(10) Pub. No.: US 2015/0312697 A1
(43) Pub. Date: Oct. 29, 2015

(54) DYNAMIC DECLARATION OF CONFORMITY AND CERTIFICATION FOR RADIO APPLICATION DISTRIBUTION

(71) Applicant: Intel IP Corporation, Santa Clara, CA (US)

(72) Inventor: Markus Dominik Mueck, Unterhaching (DE)

(21) Appl. No.: 14/543,731

(22) Filed: Nov. 17, 2014

Related U.S. Application Data
(60) Provisional application No. 61/985,343, filed on Apr. 28, 2014.

(51) Int. Cl. H04W 4/00

(52) U.S. Cl. CPC H04W 4/001

(57) ABSTRACT

Embodiments described herein relate generally to providing a radio application to a radio device for alteration of one or more radio characteristics of the radio device. A radio device may contact a reconfiguration market platform to request a radio application. The reconfiguration market platform may determine whether the radio device is authorized to operate the radio application. The reconfiguration market platform may contact a regulatory certificate platform to make this determination, or the reconfiguration market platform may cause the radio device to contact the regulatory certificate platform to facilitate this determination. If the reconfiguration market platform determines that the radio device is authorized to operate the radio application, the reconfiguration market platform provides the radio application to the radio device. Other embodiments may be described and/or claimed.

### CROSS REFERENCE TO RELATED APPLICATIONS

This application claims priority under 35 U.S.C. §119(e) to U.S. Provisional Patent Application No. 61/985,343, entitled “Solutions for Dynamic Declaration of Conformity (DoC) and Certification under the New Radio Equipment Directive” and filed Apr. 28, 2014. The disclosure of this provisional application is incorporated herein by reference.

### FIELD

Embodiments of the present invention relate generally to the technical field of data processing, and more particularly, to computer devices operable to communicate data over a network.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by their inclusion in this section.

Due to various conditions and/or regulations, a mobile radio device may necessarily conform to one or more requirements promulgated in a geographic location (e.g., a country or region) in order to be allowed to be operated. Often, a manufacturer or distributor of the mobile radio device may perform one or more tests to certify that the mobile radio device operates in conformance with the one or more requirements. This certification process may be performed before the mobile radio device is delivered to an end user (e.g., a customer). To indicate conformance with the certification process information related to the conformance may be printed on the mobile radio device.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they may mean at least one.

FIG. 1 is a block diagram illustrating an environment in which a radio application is to alter one or more radio characteristics of a radio device, in accordance with various embodiments

FIG. 2 is a block diagram illustrating an environment for providing a radio application to a radio device based on acquisition of information associated with a DoC, in accordance with various embodiments.

FIG. 3 is a sequence diagram illustrating systems and operations associated with provision of a radio application to a radio device based on authorization facilitated by a reconfiguration market platform, in accordance with various embodiments.

FIG. 4 is a sequence diagram illustrating systems and operations associated with provision of a radio application to a radio device based acquisition of information associated with a DoC by the radio device and/or network operator, in accordance with various embodiments.

FIG. 5 is a sequence diagram illustrating systems and operations associated with enforcing authorized operation of a radio application by a radio device based on authorization confirmation performed by a regulatory certificate platform, in accordance with various embodiments.

FIG. 6 is a sequence diagram illustrating systems and operations associated with issuing a certificate associated with a DoC for authorization of a radio application, in accordance with various embodiments.

FIG. 7 is a sequence diagram illustrating systems and operations associated with updating information associated with a DoC to indicate applicability to a radio application, in accordance with various embodiments.

FIG. 8 is a sequence diagram illustrating systems and operations associated with provision of operational parameters by an operational database, in accordance with various embodiments.

FIG. 9 is a sequence diagram illustrating systems and operations associated with storage and provision of information associated with a DoC at a reconfiguration database, in accordance with various embodiments.

FIG. 10 is a sequence diagram illustrating systems and operations associated with accessing a resource for information associated with a DoC, in accordance with various embodiments.

FIG. 11 is a flow diagram illustrating a method for requesting a radio application for operation by a radio device, in accordance with various embodiments.

FIG. 12 is a flow diagram illustrating a method for providing a radio application to a radio device by a computer system, in accordance with various embodiments.

FIG. 13 is a flow diagram illustrating a method for providing information associated with a declaration of conformity by a computer system for authorization of a radio application for a radio device, in accordance with various embodiments.

FIG. 14 is a block diagram illustrating a computing device adapted to operate in a communication network, in accordance with various embodiments.

FIG. 15 is a block diagram illustrating a radio device, in accordance with various embodiments.

FIG. 16 is a block diagram illustrating a computer system, in accordance with various embodiments.

### DETAILED DESCRIPTION

In the following detailed description, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the terms “module” and/or “logic” may refer to, be part of, or include an Application Specific Integrated Circuit (“ASIC”), an electronic circuit, a processor (shared, dedicated, or group), and/or memory (shared, dedicated, or group) that execute one or more software or firmware programs, a combinational logic circuit, and/or other suitable hardware components that provide the described functionality.

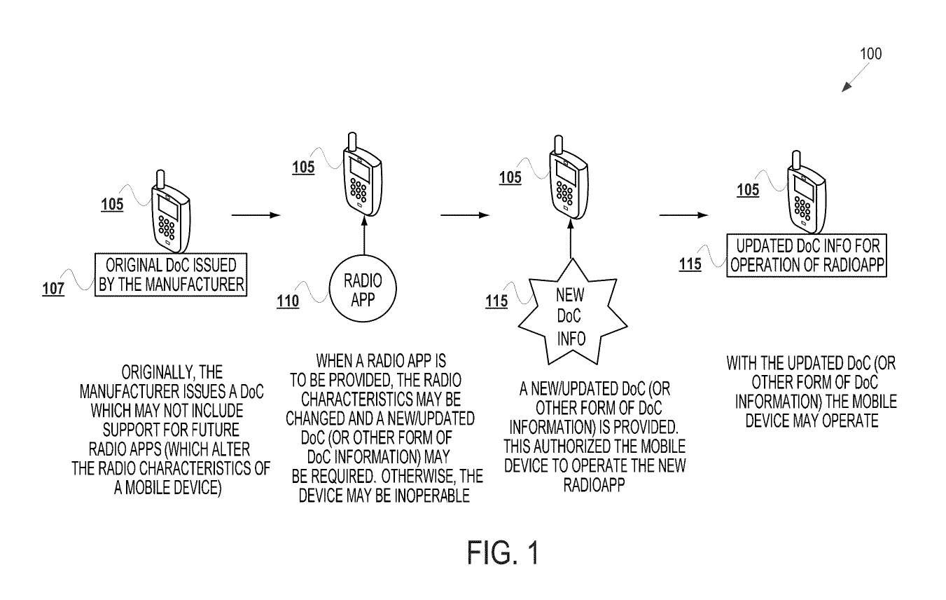

Beginning first with FIG. 1, a block diagram shows an environment 100 in which a radio application 110 is to alter one or more radio characteristics of a radio device 105, in accordance with various embodiments. The radio device 105 may be any type of computing device equipped with broadband circuitry and adapted for wireless communication. For example, the radio device 105 may be adapted to operate on a wireless cell according to, for example, one or more 3^{rd} Generation Partnership Project (“3GPP”) technical specifications. In various embodiments, the radio device 105 may be a mobile radio device, a user equipment (“UE”), a netbook, a tablet computer, a handheld computing device, a web-enabled appliance, a gaming device, a mobile phone, a smartphone, an eBook reader, a personal data assistant, or the like. In another embodiment, the radio device 105 may be a computing device that is not primarily adapted for user communications (e.g., voice calling, text/instant messaging, web browsing), such as a smart metering device, payment device (e.g., a “pay-as-you-drive” device), a vending machine, a telematics system (e.g., a system adapted for tracking and tracing of vehicles), a security system (e.g., a surveillance device), and the like.

The radio device 105 may operate in conformance with one or more requirements for a specific geographic area (e.g., a country or region). For example, the Radio Equipment Directive (“RED”) defines the underlying regulation framework for radio devices in Europe. To certify conformance with the one of more requirements, the radio device 105 may be associated with a declaration of conformity (“DoC”), which may be accessible thereat and/or stored therein.

Initially, an original DoC 107 that applies the radio device 105 may certify that the radio device 105 conforms to the one or more requirements at the point of distribution from a manufacturer. This original DoC 107 may not include support for one or more radio applications, which may alter one or more radio characteristics of the radio device 105.

According to one embodiment, the original DoC 107 may be a document, such as a static file or even a tangible component (e.g., a printed DoC affixed to the radio device 105). In such embodiments, the original DoC 107 may include an indication that a radio application may alter one or more radio characteristics of the radio device 105 if such a radio application is accompanied by supplementary and/or complementary information associated with the DoC 107 that is to indicate authorization information associated with the modifications. Such supplementary and/or complementary information may be known as a “certificate,” “passport,” “identification (‘ID’) card,” “permit,” “license,” “commitment,” “card, “green card,” “yellow card,” “blue card,” “white card,” “allowance,” delegation,” “delegation act,” “token,” “certification token,” or any other identifier (herein after, “certificate”).

According to another embodiment, the original DoC 107 may comprise an indication of an external resource (e.g., server and/or database). For example, the original DoC 107 associated with (e.g., accessible at and/or stored therein) the radio device 105 may comprise a uniform resource identifier (“URI”) or other pointer. This external resource may include current and valid DoC-associated information (and, therefore, may be updatable to account for radio applications). The radio device 107 may access the external resource to ascertain the current and valid DoC-associated information. In one embodiment, the original DoC 107 may comprise a code or other identification number that may be used when contacting the external resource.

In some embodiments, a plurality of DoCs (including the original DoC 107) may be applicable to the radio device 105. For example, the original DoC 107 may be applicable to all radio devices, including the radio device 105, and a second DoC may be applicable to only mobile UEs, such as the radio device 107. While both the original DoC 107 and the second DoC may be applicable to the radio device 107, a third DoC may only be applicable to base stations and, therefore, the third DoC may be inapplicable to the radio device 107 but both the original DoC 107 and the third DoC would be applicable to base stations.

After distribution from the manufacturer, one or more radio characteristics of the radio device 105 may need to be altered (e.g., to adjust frequency ranges in a region, if a user of the radio device 105 wishes to use the radio device 105 in a different region, etc.). To facilitate the alteration of radio characteristics, a radio application 110 may be provided to the radio device 105.

In various embodiments, the radio application 110 may alter one or radio characteristics associated with one or more of an antenna or antenna selection of the radio device 105, a frequency band to be used by the radio device 105 for wireless communication, an output power level, or essentially any other radio characteristic of the radio device 105. In at least one embodiment, the radio application 110 is not and/or does not alter a software-defined radio (“SDR”). Rather the radio application 110 is to alter radio characteristics at one or more lower layers of a protocol stack implemented in the radio device 105, such as a data link layer, a radio link control (“RLC”) layer, a packet data convergence protocol (“PDCP”) layer, a media access control (“MAC”) layer, and/or a physical (“PHY”) layer.

In one embodiment, the radio device 105 may request the radio application 110. For the radio application 110 to be provided, however, the radio application 110 may be verified to alter the one or more radio characteristics of the radio device 105. Therefore, the radio device 105 may determine whether the radio application 110 is authorized to alter the one or more radio characteristics of the radio device 105 based on information associated with a DoC 115. In various embodiments, this information may update, replace, and/or supplement the original DoC 107. The new DoC-associated information 115 may indicate that the radio application 110 is authorized to alter one or more radio characteristics of the radio device 105 and, therefore, the radio application 110 may be provided to the radio device 105. Subsequently, the radio device 105 may operate the radio application 110 to alter one or more of radio characteristics.

In some embodiments, the radio device 105 may install and/or operate another radio application (not shown) in addition to the radio application 110. However, the radio device 105 may be constrained as to the combination of radio applications that alter the one or more radio characteristics. For example, the radio device 105 may be authorized to operate the radio application 110, but not simultaneously operate another radio application that affects the radio characteristics. In another example, the radio device 105 may be authorized to operate the radio application 110, but only during concurrent operation of another radio application. The original DoC 107 and/or new DoC-associated information 115 may include and/or reference information associated with a combination of radio applications that may concurrently alter one or more radio characteristics of the radio device 105.

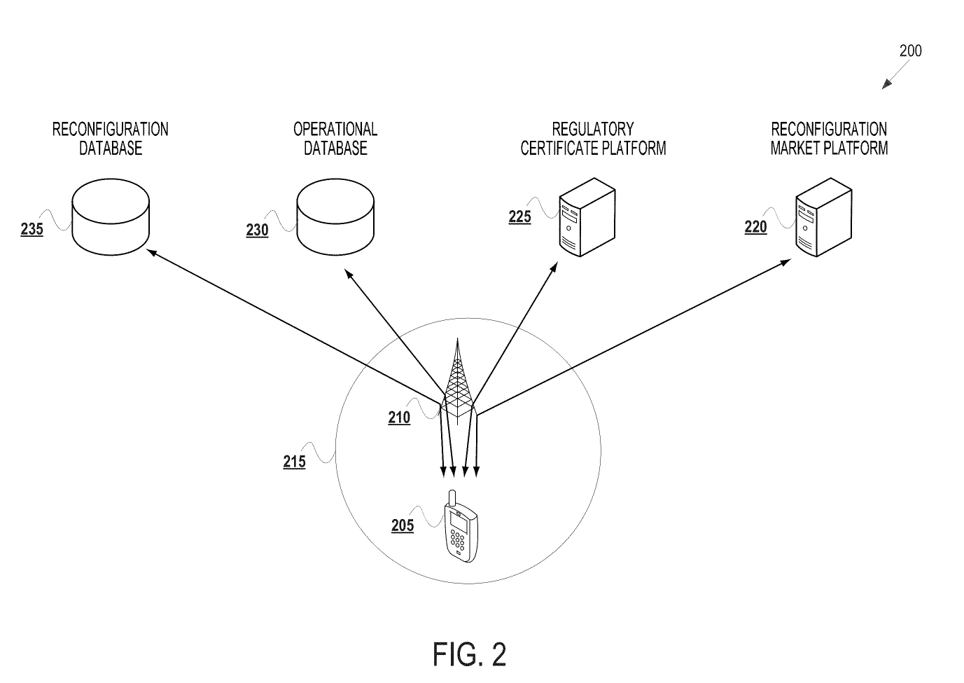

Turning now to FIG. 2, a block diagram shows an environment 200 for providing a radio application to a radio device 205 based on acquisition of information associated with a DoC, in accordance with various embodiments. The radio device 205 may be an embodiment of the UE 105 of FIG. 1.

According to embodiments, the radio device 205 may be configured for intersystem communication by operating on one a wireless cell 215 provided by a base station 210. The base station 210 may be, for example, an evolved Node B (“eNB”). In the environment 200, one or more components 205-210 and 220-235 may operate in accordance with one or more of a cellular wide area radio communication technology (which may include e.g. a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology (e.g. Universal Mobile Telecommunications System (“UMTS”), Freedom of Multimedia Access (“FOMA”), 3GPP Long Term Evolution (“LTE”), 3GPP LTE Advanced (“LTE-A”), Code division multiple access 2000 (“CDMA2000”), Cellular Digital Packet Data (“CDPD”), Mobitex, Third Generation (“3G”), Circuit Switched Data (“CSD”), High-Speed Circuit-Switched Data (“HSCSD”), Universal Mobile Telecommunications System (Third Generation) (“UMTS (3G)”), Wideband Code Division Multiple Access (Universal Mobile Telecommunications System) (“W-CDMA (UMTS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-TDD”), Time Division-Code Division Multiple Access (“TD-CDMA”), Time Division-Synchronous Code Division Multiple Access (“TD-SCDMA”), 3rd Generation Partnership Project Release 8 (Pre-4th Generation) (“3GPP Rel. 8 (Pre-4G)”), 3rd Generation Partnership Project Release 9 (“3GPP Rel. 9”), 3rd Generation Partnership Project Release 10 (“3GPP Rel. 10”), 3rd Generation Partnership Project Release 11 (“3GPP Rel. 11”), 3rd Generation Partnership Project Release 12 (“3GPP Rel. 12”), 3rd Generation Partnership Project Release 13 (“3GPP Rel. 13”), 3rd Generation Partnership Project Release 14 (“3GPP Rel. 14”), UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication System/Extended Total Access Communication System (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), Norwegian Offentlig Landmobil Telefoni (“OLT”), Public Land Mobile Telephony, Swedish Mobiltelefonisystem D or Mobile telephony system D (“MTD”), Public Automated Land Mobile (“Autotel/PALM”), Finnish Autoradiopuhelin (car radio phone) (“ARP”), Nordic Mobile Telephony (“NMT”), a High capacity version of Nippon Telegraph and Telephone (“NTT”) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, or Unlicensed Mobile Access (“UMA,” also referred to as 3GPP Generic Access Network, or GAN standard).

In various embodiments, the base station 210 may connect the radio device 105 to at least one of a reconfiguration market platform (“RMP”) 220, a regulatory certificate platform (“RCP”) 225, an operational database 230, and/or a reconfiguration database 235. In some embodiments, one or more of the RMP 220, RCP 225, operational database 230, and/or reconfiguration database 235 may be collocated and/or implemented in a same computing system. In some embodiments, one or more of the RMP 220, RCP 225, operational database 230, and/or reconfiguration database 235 may be implemented as part of a core network.

In embodiments, the radio device 205 may be adapted to transmit a request for a radio application to the base station 210. At least one of the RMP 220, RCP 225, operational database 230, and/or reconfiguration database 235 may facilitate, based on the request, a determination of whether the radio application is authorized to alter one or more radio characteristics of the radio device 205 based on the radio application. At least one of the RMP 220, RCP 225, operational database 230, and/or reconfiguration database 235 may transmit, through the base station 210, the radio application to the radio device 205.

According to one embodiment, the radio device 205 is to transmit a request for the radio application to the RMP 220. The RMP 220 may be any computing system adapted to transmit data and, therefore, may include storage circuitry (e.g., memory), processing circuitry (e.g., including one or more processors), and/or transceiver circuitry (e.g., receiver circuitry and/or transmitter circuitry). In one embodiment, the RMP 220 may be a server or cloud center. The RMP 220 may store one or more radio applications that are to affect one or more radio characteristics of one or more radio devices.

The RMP 220 may be adapted to respond to the request from the radio device 205. In embodiments, the RMP 220 may only provide a radio application to the radio device 205 if the RMP 220 is able to verify that the radio application is authorized to alter one or more of the radio characteristics of the radio device 205.

In one embodiment, the RMP 220 may still provide the radio application to the radio device 205 where the radio application is not immediately able to alter one or more radio characteristics of the radio device 205. For example, the radio application may only be authorized to alter one or more radio characteristics for radio devices in Germany, but not in France. In such an example, the RMP 220 may still provide the radio application to the radio device 205 where the radio device 205 is located in France, even though the radio device 205 may be unable to install and/or modify one or more radio characteristics using the radio application until the radio device 205 arrives in Germany.

The RCP 225 may be adapted to manage and/or facilitate the authorized installation and/or operation of one or more radio applications by the radio device 205. The RCP 225 may be any computing system adapted to transmit data and, therefore, may include storage circuitry (e.g., memory), processing circuitry (e.g., including one or more processors), and/or transceiver circuitry (e.g., receiver circuitry and/or transmitter circuitry). In one embodiment, the RCP 225 may be a server or cloud center. In one embodiment, the RCP 225 may be communicatively coupled with the RCP 220.

In various embodiments, the RCP 225 may manage and/or store information associated with a DoC. In one embodiment, the RCP 225 may manage and/or store certificates that are to supplement an existing DoC. For example, a hardware manufacturer (e.g., a manufacturer of the radio device 205 or another responsible entity) may issue a DoC indicating that the DoC covers the original radio characteristics of the radio device 205 as well as future alterations to radio characteristics (e.g., radio applications), as long as those future alternations are authorized, for example, by a certificate or other DoC-associated information. In some embodiments, the RCP 225 may enforce one or more requirements to ensure that the radio device 205 is operating a radio application authorized by DoC-associated information. Where the RCP 225 determines that the radio device 205 is not authorized to operate a radio application, the RCP 225 may instruct the radio device 205 to cease operation of the radio application and/or transition to a safe mode suitable for the geographic location in which the radio device 205 is located.

In various embodiments, the RCP 225 may be operated by one or more National Regulation Administration (“NRA”), another similar organization (e.g., the Federal Communications Commission (“FCC”), the European Conference of Postal and Telecommunications Administrations (“CEPT”), or the like), and/or a third party with a mandate from a similar regulatory entity. Therefore, the RCP 225 may comprise a “knowledge center” for the management and/or storage of information associated with one or more DoCs. The RCP 225 may receive information associated with DoCs, for example, from a manufacturer or another entity associated with the radio device 205 and/or a network of which the base station 210 is a part. In some embodiments, the RCP 225 may transmit DoC-associated information to a database (e.g., the reconfiguration database 235 for storage and/or retrieval by the RCP 225. The RCP 225 may further receive information invalidating DoC-associated information, such as an indication that a DoC is expired.

In some embodiments, the environment 200 may include an operational database 230. The operational database 230 may be any computer system adapted to store data and, therefore, may include storage circuitry (e.g., memory) and, optionally, processing circuitry (e.g., including one or more processors). In various embodiments, the operational database 230 may be adapted to transmit and/or receive data and, therefore, may include transmitter and/or receiver circuitry. In various embodiments, the operational database 230 may be communicatively coupled and/or integrated with the RMP 220 and/or the RCP 225. In various embodiments, the operational database 230 may be implemented as part of a server or cloud center.

According to embodiments, the operational database 230 may store one or more operational parameters associated with alteration of the one or more radio characteristics of the radio device 205 by the radio application. In embodiments, the one or more operational parameters may comprise one or more output power levels (e.g., maximum output power levels for given geographic locations, given time intervals, given frequency bands, and the like), one or more acceptable frequency bands (e.g., one or more frequency bands for communication by the radio device 205 in a given geographic location, given time interval, and the like), one or more operator preferences (e.g., priority to one system (e.g., LTE) over another (e.g., WiFi)), frequency spectrum sharing constraints, one or more constraints on operation of the radio application (e.g., constraints indicating the radio application cannot be run in conjunction with another radio application and/or indicating that the radio application must be run in conjunction with an additional radio application), and/or other similar operational parameters.

When the radio device 205 is operating a radio application that alters one or more radio characteristics, the operational parameters need to be available to the radio device 205 to ensure that the radio device is compliantly operating. Should such operational parameters be unavailable or expired, then the radio device 205 may be unable to continuation operation using the radio application (e.g., the radio device 205 may uninstall the radio application and/or may transition to a safe state and/or original configuration state).

In some embodiments, the operational database 230 may determine operational parameters applicable to the radio device 205 based on a location of the radio device 205 In various embodiments, the location of the radio device 205 may be coarse or rough, and so does not necessarily need to be exact. In various embodiments, the operational database 230 may obtain the location information from the radio device 205 and/or from a network associated with the radio device 205. In various embodiments, the location may be ascertained, for example, by triangulation, a satellite navigation system, information from the base station 210 to which the radio device 205 is attached (e.g., an identifier of the cell 215), device-to-device (“D2D”) based location estimation, location estimation based on an environment in which the radio device 205 is located (e.g., scanning of codes, such as a Quick Response (“QR”) code).

In various embodiments, the operational database 230 may be communicatively coupled with one or more other systems (not shown) to determine one or more operational parameters. For example, the operational database 230 may be communicatively coupled with a television white space database and/or a licensed shared access (“LSA”) repository/database.

In some embodiments, the environment 200 may include a reconfiguration database 235. The reconfiguration database 235 may be any computer system adapted to store data and, therefore, may include storage circuitry (e.g., memory) and, optionally, processing circuitry (e.g., including one or more processors). In various embodiments, the reconfiguration database 235 may be adapted to transmit and/or receive data and, therefore, may include transmitter and/or receiver circuitry. In various embodiments, the reconfiguration database 235 may be communicatively coupled and/or integrated with the RMP 220 and/or the RCP 225. In various embodiments, the reconfiguration database 235 may be implemented as part of a server of cloud center.

In various embodiments, the reconfiguration database 235 may be associated with facilitating the operations associated with the RCP 225. The reconfiguration database 235 may store information associated with one or more DoCs. The reconfiguration database 235 may receive this information, for example, from the RCP 225 and/or from a manufacturer or another entity associated with the radio device 205 and/or a network of which the base station 210 is a part. The reconfiguration database 235 may additionally receive information invalidating DoC-associated information, such as an indication that DoC-associated information is expired.

In various embodiments, the reconfiguration database 235 may be adapted to provide DoC-associated information to the RCP 225 in response to a request from the RCP 225. In one embodiment, DoC-associated information may be redundantly stored in both the RCP 225 and the reconfiguration database 235. In such an embodiment, the redundant storage may facilitate verification of DoC-associated information. For example, the RCP 225 may be adapted to compare DoC-associated information stored in the RCP 225 to expectedly redundant DoC-associated information at the reconfiguration database 235, and if the expectedly redundant DoC-associated information does not match that DoC-associated information stored at the RCP 225 the RCP 225 may infer that the DoC-associated information is invalid. This verification of DoC-associated information may prevent malicious attacks, corrupted data, and the like.

In some embodiments, the RCP 225 may provide validation of information provided by the reconfiguration database 235—e.g., where DoC-associated information and/or certification information is provided by the reconfiguration database 235, the RCP 225 may guarantee the validity of such provided information. Further, the RCP 225 may control and/or manage the reconfiguration database 235 to ensure that the reconfiguration database 235 only provides information according to one or more criterion.

After the radio application is provided to the radio device 205, the radio device 205 may operate the radio application based on comparing, and adjusting if necessary, operational characteristics of the radio device 205 to operational parameters associated with operation of the radio application by the radio device 205 (e.g., operational parameters provided by the operational database 230, the RMP 220, and/or preconfigured). The operational characteristics of the radio device may include one or more output power levels (e.g., an output power level at the current geographic location of the radio device 205, an output power level at the current time, output power levels for one or more current frequency bands used by the radio device 205 for communication, and the like), one or more frequency bands used or available to the radio device 205, one or more radio access technologies (“RATs”) used or available to be used by the radio device 205 (e.g., LTE, WiFi, etc.), one or more shared frequency spectrums, one or more other radio applications operated by or available to be operated by the radio device 205, and/or other similar operational characteristics.

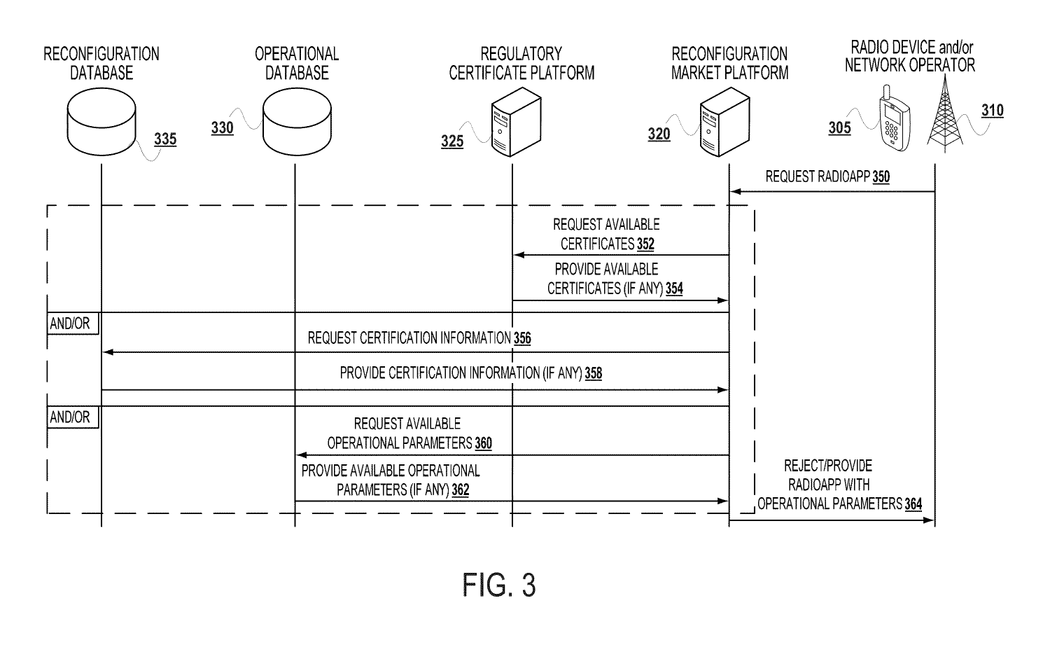

With respect to FIG. 3, a sequence diagram illustrates systems and operations associated with provision of a radio application to a radio device 305 based on authorization facilitated by an RMP 320, in accordance with various embodiments. According to various embodiments, the radio device 305 may be an embodiment of the radio device 205, the RMP 320 may be an embodiment of the RMP 220, the RCP 325 may be an embodiment of the RCP 225, the operational database 330 may be an embodiment of the operational database 230, and/or the reconfiguration database 335 may be an embodiment of the reconfiguration database 235, as illustrated in FIG. 2. The network operator 310 may operate the base station 210 of FIG. 2.

Beginning with operation 350, the radio device 305 may transmit a request associated with a radio application to the RMP 320. In various embodiments, this request may include information associated with the radio application (e.g., an identifier associated with the radio application, a type of radio application, and/or the like). In various embodiments, this request may comprise information associated with a search for information associated with a DoC. For example, the request may include one or more of a type of the radio device 305, a code of the radio device 305, an identifier associated with the radio device 305, one or more certificates available to the radio device 305 (e.g., stored therein or accessible at), a current DoC available to the radio device 305 (e.g., stored therein or accessible at), a version associated with a DoC and/or a certificate, or other similar information.

At operation 352, the RMP 320 may transmit a request to the RCP 325 to determine if there are one or more certificates available for the radio device 305. According to embodiments, this request may include information included in the request for the radio application from the radio device 305. At operation 354, the RCP 325 identifies any certificates based on the request from the RMP 320 and, if there are any certificates identified, transmits the one or more identified certificates to the RMP 320.

In some embodiments, the RMP 320 may query the reconfiguration database 335 to request any certification information, as shown at operation 356. In various embodiments, the RMP 320 may request the certification information based on certificate(s) provided by the RCP 325, information included in the request from the radio device 305 for the radio application, and/or the information about the radio application. In one embodiment, the result of the query of the reconfiguration database 335 indicates whether the radio application is authorized to alter one or more radio characteristics. In one embodiment, the result of the query may include information associated with existing certificates (e.g., a certificate provided by the RCP 325) and/or operational parameters associated with the radio application.

At operation 360, the RMP 320 may access the operational database 330 to request any available operational parameters associated with operation of the radio application by the radio device 305. In various embodiments, the RMP 320 may request the operational parameters based on information included in the request from the radio device 305 for the radio application and/or the information about the radio application. At operation 362, the operational database 330 returns the operational parameters, if any are available.

According to various embodiments, one or more of the operations 352-362 may be omitted and/or transposed. For example, the operational parameters may be preconfigured in the RMP 320 and/or the radio device 305 (e.g., operational parameters may be preconfigured when a DoC and/or certificate is issued). In some embodiments, the RMP 320 may contact a database operated by the NRA, another similar organization (e.g., the FCC, the CEPT, or the like), and/or a third party with a mandate from a similar regulatory entity to receive certification information, instead of the reconfiguration database 335.

In various embodiments, the RMP 320 may determine if any of the certificate(s) information from the RCP 325 and/or the reconfiguration database 335 indicates that the requested radio application is authorized to alter one or more radio characteristics of the radio device 305. According to one embodiment of operation 364, the RMP 320 transits the radio application, and any applicable operational parameters, to the radio device 305 if the RMP 320 determines that the radio device 305 is authorized to operate the radio application. The radio device 305 may then operate the radio application to alter one or more radio characteristics of the radio device 305, taking into account the operational parameters associated with operation of the radio application. Alternatively, the RMP 320 transmits, to the radio device 305, an indication that the radio device 305 is not authorized to operate the radio application if the RMP 320 determines that the radio device is not authorized to operate the radio application.

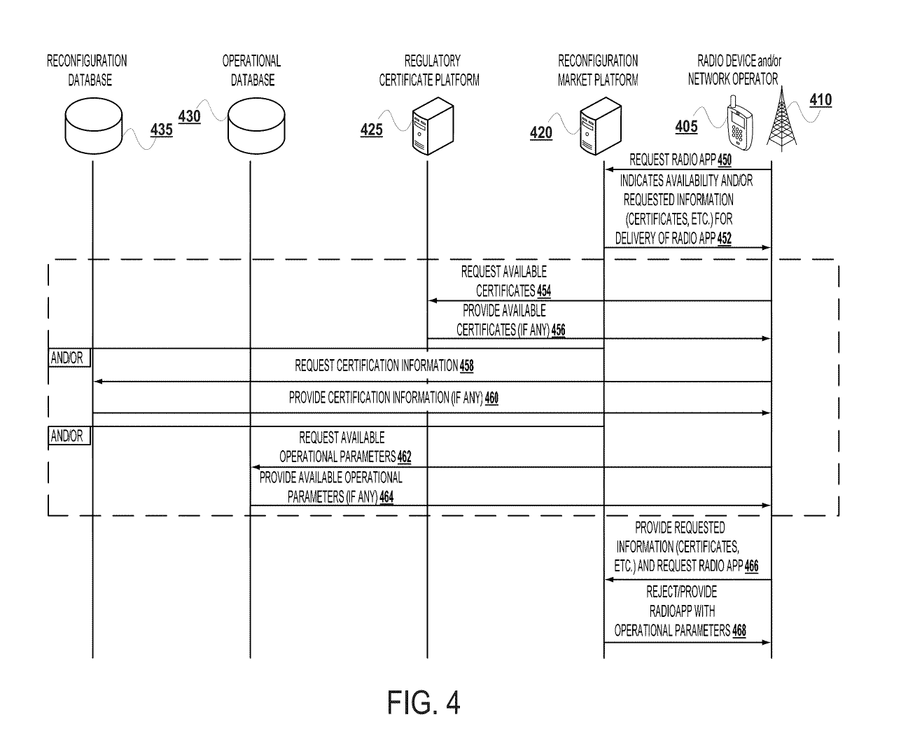

With respect to FIG. 4, a sequence diagram illustrates systems and operations associated with provision of a radio application to a radio device 405 based acquisition of information associated with a DoC by the radio device 405 and/or network operator 410, in accordance with various embodiments. According to various embodiments, the radio device 405 may be an embodiment of the radio device 205, the RMP 420 may be an embodiment of the RMP 220, the RCP 425 may be an embodiment of the RCP 225, the operational database 430 may be an embodiment of the operational database 230, and/or the reconfiguration database 435 may be an embodiment of the reconfiguration database 235, as illustrated in FIG. 2. The network operator 410 may operate the base station 210 of FIG. 2.

In various embodiments, the network operator 410 may operate a network that connects the radio device 405 to the components 420-435 through a base station. Although various operations 450-468 of FIG. 4 are illustrated as performed by the radio device 405, one or more of these operations 450-468 may be performed by a network operator 410 associated with the radio device 405 (e.g., on behalf of the radio device 405).

Beginning with operation 450, the radio device 405 may transmit a request associated with a radio application to the RMP 420. In various embodiments, this request may include information associated with the radio application (e.g., an identifier associated with the radio application, a type of radio application, and/or the like). In various embodiments, this request may comprise information associated with a search for information associated with a DoC. For example, the request may include one or more of a type of the radio device 405, a code of the radio device 405, an identifier associated with the radio device 405, one or more certificates available to the radio device 405 (e.g., stored therein or accessible thereat), a current DoC accessible at the radio device 405 (e.g., stored therein or accessible thereby), a version associated with a DoC and/or a certificate, or other similar information.

Based on the request, the RMP 420 may determine the availability and/or information that is to be provided by the radio device 405 in order for the requested radio application to be provided. If the radio application is not available, the RMP 420 may indicate the unavailability to the radio device 405, as shown at operation 452. Alternatively, the RMP 420 may transmit an indication of the information that is to be provided to the RMP 420 in order to verify that the radio device 405 is authorized to operate the radio application. This indication may comprise an indication of information associated with a DoC (e.g., one or more certificates that are to be provided by the radio device 405), an indication of another radio application operated by the radio device 405, one or more operational characteristics of the radio device 405, or other similar information to verify that the radio device 405 is authorized to operate the radio application.

Based on the response from the RMP 420, the radio device 405 may transmit a request to the RCP 425, as illustrated at operation 454. The request may comprise an indication of information associated with a DoC (e.g., one or more certificates that are to be provided by the radio device 405). In some embodiments, this request may include may include one or more of a type of the radio device 405, a code of the radio device 405, an identifier associated with the radio device 405, one or more certificates available to the radio device 405 (e.g., stored therein or accessible thereat), a current DoC associated with the radio device 405 (e.g., stored therein or accessible thereat), a version associated with a DoC and/or a certificate, information associated with the requested radio application, and/or other similar information. At operation 456, the RCP 425 identifies any certificates based on the request and, if there are any certificates identified, transmits the one or more identified certificates to the radio device 405.

In some embodiments, the radio device 405 may query the reconfiguration database 435 to request any certification information, as shown at operation 458. In various embodiments, the radio device 405 may request the certification information based on certificate(s) provided by the RCP 425, information associated with the radio device 405, and/or information about the radio application. In one embodiment of operation 460, the result of the query of the reconfiguration database 405 may include a value (e.g., a code) to be used to verify that the radio device 405 is authorized to operate the radio application. In one embodiment of operation 460, the result of the query may include information associated with existing certificates (e.g., a certificate provided by the RCP 425) and/or operational parameters associated with the radio application.

At operation 462, the radio device 405 may access the operational database 830 to request any available operational parameters associated with operation of the radio application by the radio device 405. In various embodiments, the radio device 405 may request the operational parameters based on information associated with the radio device 405 and/or the information about the radio application. At operation 464, the operational database 430 may return the operational parameters, if any are available.

According to various embodiments, one or more of the operations 454-464 may be omitted and/or transposed. For example, the operational parameters may be preconfigured in the radio device 405 and/or the RMP 420 (e.g., operational parameters may be preconfigured when a DoC and/or certificate is issued). In some embodiments, the radio device 405 may contact a database operated by the National Regulation Administration, another similar organization (e.g., the FCC, the CEPT, or the like), and/or a third party with a mandate from a similar regulatory entity to receive certification information, instead of or in addition to the reconfiguration database 435. In some embodiments, the RMP 420 may access the operational database 430 to retrieve the operational parameters.

At operation 466, the radio device 405 may transmit the information, indicated by the RMP 420 as required for provision of the radio application, received from one or more of the RCP 425, the reconfiguration database 435, and/or the operational database 430. For example, this information may be associated with a DoC (e.g., a certificate), information associated with the radio device 405, and/or information associated with the radio application.

In various embodiments, the RMP 420 may determine if any of the information provided by the radio device 405 indicates that the radio device 405 is authorized to operate the requested radio application. According to one embodiment of operation 468, the RMP 420 transits the radio application, and any applicable operational parameters, to the radio device 405 if the RMP 420 determines that the radio device 405 is authorized to operate the radio application based on the determination if the provided information indicates authorization. The radio device 405 may then operate the radio application to alter one or more of the radio characteristics of the radio device 405, taking into account the operational parameters associated with operation of the radio application. Alternatively, the RMP 420 transmits, to the radio device 405, an indication that the radio device 405 is not authorized to operate the radio application if the RMP 420 determines that the information provided by the radio device 405 indicates that the radio device 405 is not authorized to operate the radio application.

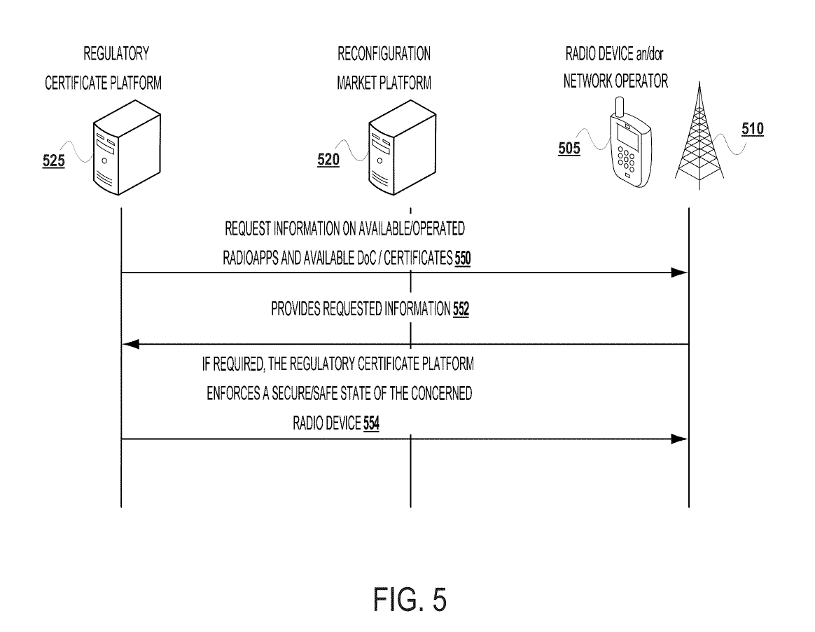

With respect to FIG. 5, a sequence diagram illustrates systems and operations associated with enforcing authorized operation of a radio application by a radio device 505 based on authorization confirmation performed by the RCP 525, in accordance with various embodiments. According to various embodiments, the radio device 505 may be an embodiment of the radio device 205, the RMP 520 may be an embodiment of the RMP 220, and/or the RCP 525 may be an embodiment of the RCP 225, as illustrated in FIG. 2. The network operator 510 may operate the base station 210 of FIG. 2.

In various embodiments, the network operator 510 may operate a network that connects the radio device 505 to the components 520-525 through a base station. Although various operations 550-554 of FIG. 4 are illustrated as performed by the radio device 505, one or more of these operations 550-554 may be performed by a network operator 510 associated with the radio device 505 (e.g., on behalf of the radio device 505).

In various embodiments, the RCP 520 may be adapted to check whether one or more radio devices (including the radio device 505) are operating one or more radio applications in accordance with DoC-associated information, such as a current DoC and/or one or more certificates. Thus, at operation 550 the RCP 525 may transmit a request for information associated with available radio applications (e.g., one or more radio applications stored at the radio device 505 but not currently operated) and/or operated radio applications (e.g., one or more radio applications currently operated by the radio device 505 to alter one or more radio characteristics of the radio device 505). Further, the RCP 525 may transmit a request for information associated with a DoC, such as a DoC that is currently accessible at the radio device 505 and/or one or more certificates that are available to the radio device 505.

In one embodiment, the requests associated with radio applications and DoC-associated information may be transmitted to the network operator 510 to request information from a plurality of radio devices (including the radio device 505) in a given location (e.g., all currently active radio devices, all radio devices currently served by a given base station, etc.).

At operation 552, the radio device 505 is to provide, to the RCP 525, an indication of the one or more radio applications available to and/or operated by the radio device 505. Further, the radio device 505 is to provide, to the RCP 525, an indication of information accessible at the radio device 505 that is associated with a DoC. This DoC-associated information may comprise an indication of a DoC accessible at the radio device 505 (e.g., a file stored at the radio device 505, a URI or other pointer to an external resource or information obtained from the external resource, and/or another DoC document) and/or an indication of one or more certificates available to the radio device 505.

In response to information associated with the DoC and the one or more radio applications, the RCP 525 may verify that the radio device 505 is only to operate its one or more radio applications in accordance with the DoC-associated information available to the radio device 505. For example, the RCP 525 may verify that a DoC and/or a certificate is unexpired and/or valid (e.g., not corrupted and/or counterfeit). If the RCP 525 identifies an issue with the provided DoC-associated information and, therefore, is unable to verify that the radio device 505 is operating and/or has available thereto one or more radio applications that are authorized, the RCP 525 may transmit an instruction to the radio device 505 that forces the radio device 505 into a secure and/or safe state. For example, the RCP 525 may transmit an instruction to the radio device 505 that causes the radio device 505 to cease operation of one or more radio applications that the radio device 505 is not authorized to operate and, further, cause the radio device 505 to operate with radio characteristics that do not conflict with a valid DoC (e.g., default radio characteristics) or cause the radio device 505 to cease radio transmission.

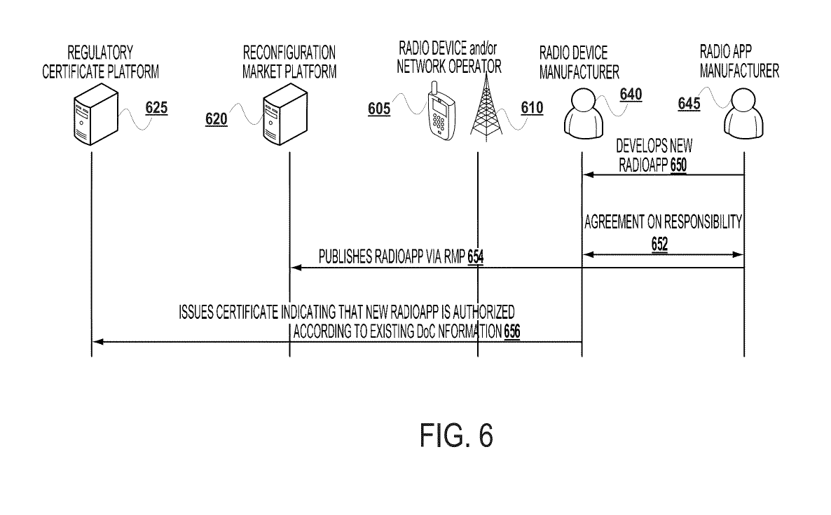

Turning to to FIG. 6, a sequence diagram illustrates systems and operations associated with issuing a certificate associated with a DoC for authorization of a radio application, in accordance with various embodiments. According to various embodiments, the radio device 605 may be an embodiment of the radio device 205, the RMP 620 may be an embodiment of the RMP 220, and/or the RCP 625 may be an embodiment of the RCP 225, as illustrated in FIG. 2. The network operator 610 may operate the base station 210 of FIG. 2.

In embodiments, the RCP 625 may manage certificates associated with a DoC and, therefore, may store DoC-associated information from a manufacturer 640 of the radio device 605 that indicates the radio characteristics of a radio device 605 are authorized by a version of a DoC. That version of the DoC may be issued by the manufacturer 640 and/or by another responsible entity, such as the NRA, another similar organization (e.g., the FCC, the CEPT, or the like), and/or a third party with a mandate from a similar regulatory entity. That version of the DoC may indicate that the radio device 605 having default radio characteristics at the point of production by the manufacturer is authorized and, additionally, future alternations to the radio characteristics of the radio device 605 by a radio application may be authorized under that version of the DoC if a certificate is issued that indicates operation of the radio application by the radio device 605 is authorized.

The operations associated with this sequence may begin with the operation 650. Here, the manufacturer 645 of a radio application develops a new radio application that is to alter the radio characteristics of the radio device 605. The radio application manufacturer 645 may communicate with a manufacturer 640 of the radio device 605, for example, to ensure compatibility with the radio device 605. At operation 652, the radio application manufacturer 645 and the radio device manufacturer 640 may communicate to reach an agreement on the entity responsible for providing information associated with a DoC that indicates the radio device 605 is authorized to operate the radio application to alter one or more radio characteristics.

At operation 654, the radio application manufacturer 645 may transmit the radio application to the RMP 620. The RMP 620 may store the radio application for later provision. Thus, the RMP 620 may be able to provide the radio application to the radio device 605 after verification that the radio device 605 is authorized to operate the radio application.

At operation 656, the radio device manufacturer 640 may transmit, to the RCP 625, an indication that a certificate is to be issued that indicates the radio application is to be authorized according to existing DoC-associated information (e.g., a DoC accessible at the radio device 605). In one embodiment, the radio device manufacturer 640 may transmit the certificate. In another embodiment, the radio device manufacturer 640 may transmit a request that the RCP 625 create the certificate.

In one embodiment, the radio application manufacturer 645 may assume responsibility for the providing information associated with a DoC that indicates the radio device 605 is authorized to operate the radio application. In such an embodiment, the radio application manufacturer 645 may perform operation 656.

The RCP 625 may store and/or manage this DoC-associated information (e.g., certificates) to facilitate verification by the RMP 620 and/or the radio device 605 that the radio application is authorized to alter one or more radio characteristics of the radio device 605. In some embodiments of operation 656, the indication that the certificate is to be issued may indicate one or more DoCs (e.g., a version, date, classification, field, or other identifier), which may correspondingly indicate one or more radio devices to which the certificate is applicable (e.g., the certificate may be applicable to a class and/or type of radio device). At the RCP 625, the certificate may indicate one or more one or more radio devices (e.g., the certificate may be applicable to a class and/or type of radio device) that are authorized to receive, install, operate, terminate, and/or uninstall the radio application to which the certificate is applicable.

In embodiments, the RCP 625 may be adapted validate the indication that the certificate is to be issued. For example, the RCP 625 may be adapted to validate that the radio device manufacturer 640 and/or the radio application 645 is/are authorized to introduce new certificates to authorize radio applications.

The RCP 625 may further be adapted to store information associated with the scope of the certificate. For example, the RCP 625 may be adapted to determine and/or store a duration during which the certificate is valid, a frequency band to which the certificate is applicable, and the like.

In one embodiment, the RCP 625 may be adapted to determine and/or store applicability information associated with the certificate. For example, in a first geographic location, the certificate may be limited in scope to a first time interval and/or a first frequency band, while in a second geographic location the certificate may be limited in scope to a time interval and/or a second frequency band.

In one embodiment, the RCP 625 may be adapted to determine and/or store specific criteria that are to be met in order to the certificate to be provided. For example, the RCP 625 may determine and/or store criteria indicating that a fee must be paid to obtain the certificate and/or that credentials must be provided to obtain the certificate (e.g., credentials indicating that the certificate is to be provided to a public safety agent).

In one embodiment, the RCP 625 may be adapted to determine and/or store compatibility information associated with the certificate. For example, the RCP 625 may be adapted to determine and/or store that, according to the certificate, the radio application cannot be operated by the radio device 605 concurrently with another radio application or that the radio device 605 must operate the radio application concurrently with the operation of another radio application.

In some embodiments, the indication that the certificate is to be issued may cause the RCP 625 to determine and/or store operational parameters. The RCP 625 may store these operational parameters at an operational database (not shown).

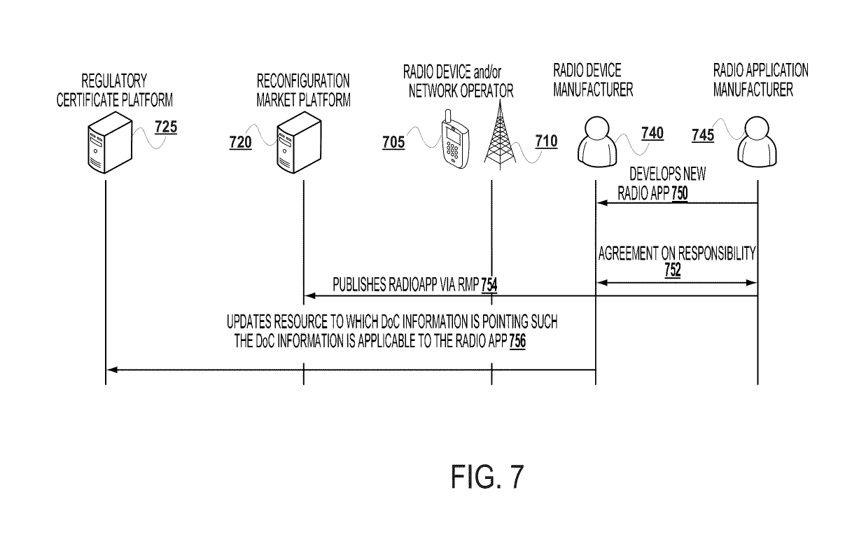

Turning to to FIG. 7, a sequence diagram illustrates systems and operations associated with updating information associated with a DoC to indicate applicability to a radio application, in accordance with various embodiments. According to various embodiments, the radio device 705 may be an embodiment of the radio device 205, the RMP 720 may be an embodiment of the RMP 220, and/or the RCP 725 may be an embodiment of the RCP 225, as illustrated in FIG. 2. The network operator 710 may operate the base station 210 of FIG. 2.

In embodiments, the RCP 725 may manage information associated with one or more DoCs. According to an embodiment, the RCP 725 may be adapted to update one or more DoCs to reflect applicability and/or authorization associated with a radio application and/or a radio device 705. By updating a DoC, the RCP 725 may obviate or circumvent one or more certificates (e.g., authorization for operation of a radio application by the radio device 705 may be indicated by the DoC itself, instead of an RCP 725). In such embodiments, information associated with a DoC may comprise a URI or other pointer that references a modifiable resource, such as an electronic file, a website, a repository, a document, or the like that indicates content of the DoC (e.g., text indicating applicability and/or authorization information for the DoC).

In various embodiments, the radio device 705 may have accessible thereto (e.g., stored therein or accessible thereat) information associated with a DoC. In various embodiments, this DoC-associated information may be a URI or other pointer to an external resource, such as an electronic file, a website, a repository, a document, or other resource modifiable by the RCP 725.

At operation 750, the manufacturer 745 of a radio application develops a new radio application that is to alter the radio characteristics of the radio device 705. The radio application manufacturer 745 may communicate with a manufacturer 740 of the radio device 705, for example, to ensure compatibility with the radio device 705. At operation 752, the radio application manufacturer 745 and the radio device manufacturer 740 may communicate to reach an agreement on the entity responsible for providing information associated with a DoC that indicates the radio device 705 is authorized to operate the radio application to alter one or more radio characteristics.

At operation 754, the radio application manufacturer 745 may transmit the radio application to the RMP 720. Thus, the RMP 720 may be able to provide the radio application to the radio device 705 after verification that the radio device 705 is authorized to operate the radio application.

At operation 756, the radio device manufacturer 740 may transmit, to the RCP 725, an indication that a resource that is referenced by a DoC is to be updated. In one embodiment, the radio device manufacturer 740 may transmit an indication that the radio device 705 is authorized to operate the radio application. In response to this indication, the RCP 725 may update the resource to reflect this authorization. Subsequently, when the resource is accessed according to the DoC accessible at the radio device 705, the resource may indicate updated authorization information, which may have been unavailable when the DoC was originally issued.

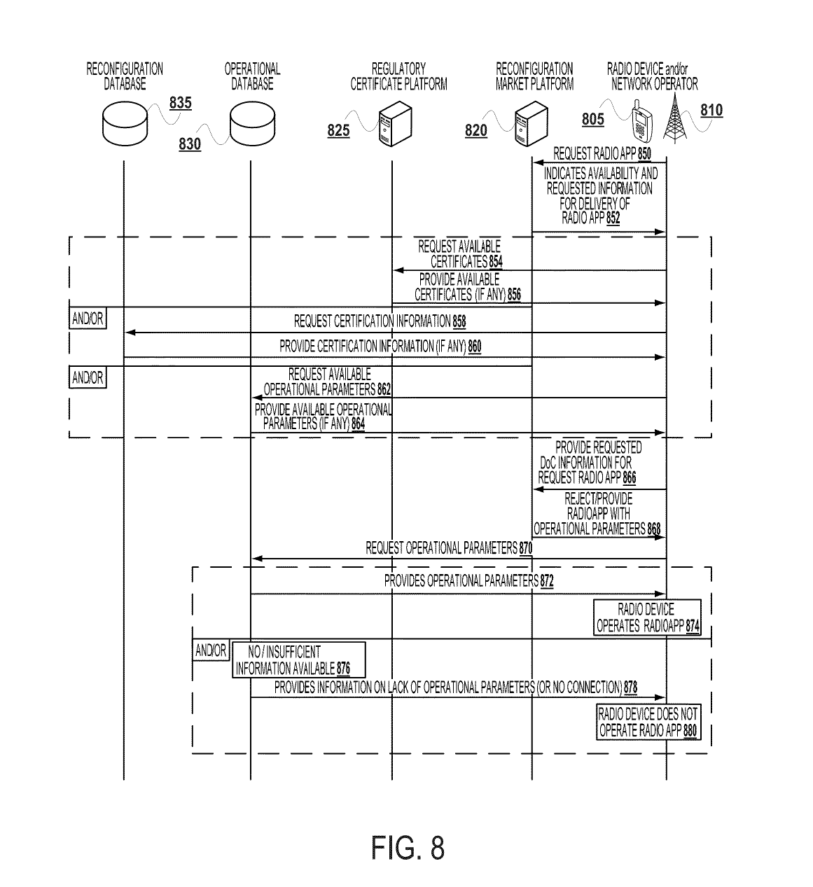

Turning to FIG. 8, a sequence diagram illustrates systems and operations associated with provision of operational parameters by an operational database 830, in accordance with various embodiments. According to various embodiments, the radio device 805 may be an embodiment of the radio device 205, the RMP 820 may be an embodiment of the RMP 220, the RCP 825 may be an embodiment of the RCP 225, the operational database 830 may be an embodiment of the operational database 230, and/or the reconfiguration database 835 may be an embodiment of the reconfiguration database 235, as illustrated in FIG. 2. The network operator 810 may operate the base station 210 of FIG. 2.

In embodiments, the operational database 830 may store operational parameters associated with operation of a radio application by the radio device 805. In various embodiments, the operational database 830 may store one or more operational parameters in connection with information associated with a DoC. For example, the operational database 830 may store one or more operational parameters and include therein an indication of an association between the one or more operational parameters and one of more DoCs, one or more certificates, and/or one or more combinations of DoC(s) and certificate(s).

Beginning with operation 850, the radio device 805 may transmit a request associated with a radio application to the RMP 820. In response to the request, the RMP 820 may determine the availability and/or information that is to be provided by the radio device 805 in order for the requested radio application to be provided. If the radio application is not available, the RMP 820 may indicate the unavailability to the radio device 805, as shown at operation 852. Alternatively, the RMP 820 may transmit an indication of the information that is to be provided to the RMP 820 in order to verify that the radio device 805 is authorized to operate the radio application.

Based on the response from the RMP 820, the radio device 805 may transmit a request to the RCP 825, as illustrated at operation 854. At operation 856, the RCP 825 identifies any certificates based on the request and, if there are any certificates identified, transmits the one or more identified certificates to the radio device 805.

In some embodiments, the radio device 805 may query the reconfiguration database 835 to request any other certification information, as shown at operation 858. At operation 860, the reconfiguration database 835 may return any certification information, such as a value (e.g., a code) to be used to verify that radio device 805 is authorized to operate the radio application and/or information associated with existing certificates.

At operation 862, the radio device 805 may access the operational database 830 to request any available operational parameters associated with operation of the radio application by the radio device 805. In various embodiments, the radio device 805 may request the operational parameters based on information associated with the radio device 805 and/or the information about the radio application. At operation 864, the operational database 830 may return the operational parameters, if any are available.

At operation 866, the radio device 805 may transmit the information, indicated by the RMP 820 as required for provision of the radio application, received from one or more of the RCP 825, the reconfiguration database 835, and/or the operational database 830. In response, the RMP 820 may determine if any of the information provided by the radio device 805 indicates that the radio device 805 is authorized to operate the requested radio application.

At operation 868, the RMP 820 may transmit the radio application together with an indication of any operational parameters applicable to operation of the radio application to the radio device 805 if the radio device 805 is authorized to operate the radio application. The radio device 805 may then operate the radio application to alter one or more of the radio characteristics of the radio device 805, taking into account the operational parameters associated with operation of the radio application from the RMP 820 and/or the operational database 830.

When the radio device 805 is operating the radio application, the operational parameters may need to be available for the context of the radio device, such as the geographic location, time, frequency band, and the like applicable to the radio device 805. In the even that such operational parameters are unavailable and/or the operational parameters expire, the radio device 805 may be unable to continue operation of the radio application. For example, the radio device 805 may be instructed to uninstall the radio application and/or instructed to enter a secure/safe state (e.g., a state of operation using default radio characteristics).

The radio device 805 may be required to access the operational database 830 after reception and/or operation of the radio application to obtain operational parameters for continued operation of the radio application. For example, the operational parameters stored at the radio device 805 may expire and, therefore, the radio device 805 may need to obtain updated or current operational parameters. In another example, the radio device 805 may move to a different geographic location at which the operational parameters stored at the radio device 805 are inapplicable and, therefore, the radio device 805 may need to obtain applicable operational parameters.

At operation 870, the radio device 805 may request, from the operational database 830, operational parameters for the radio application operated by the radio device 805. In various embodiments, this request may comprise location information associated with the radio device 805. This location information may be obtain by the radio device 805 using, for example, triangulation, a satellite navigation system, information associated with the network operator 810 (e.g., a base station to which the radio device 805 is attached), D2D-based location estimation, location estimation based on an environment in which the radio device 805 is located (e.g., scanning of codes, such as QR codes).

Based on the request, the operational database 830 may determine one or more operational parameters that are to be provided to the radio device 805 for operation of the radio application at the location of the radio device 805. At operation 872, the operational database 830 may provide the one or more operational parameters to the radio device 805. At operation 874, the radio device 805 may operate the radio application according to the one or more operational parameters applicable to the location of the radio device 805, for example, by adjusting one or more operational characteristics of the radio device 805 to comply with the operational parameters.

In some embodiments, the operational database 830 may be unable to determine any operational parameters (e.g., the radio device 805 may lack permission, the location information provided by the radio device 805 may be insufficient, etc.) and/or may be unavailable, as shown at operation 876. At operation 878, the operational database 830 may indicate to the radio device 805 that no operational parameters are available or, if the operational database is unavailable, the radio device 805 may determine that no operational parameters are obtainable. Therefore, at operation 880 the radio device 805 may cease operation of the radio application. Consequently, the radio device 805 may uninstall the radio application and/or enter a secure/safe state (e.g., a state of operation using default radio characteristics).

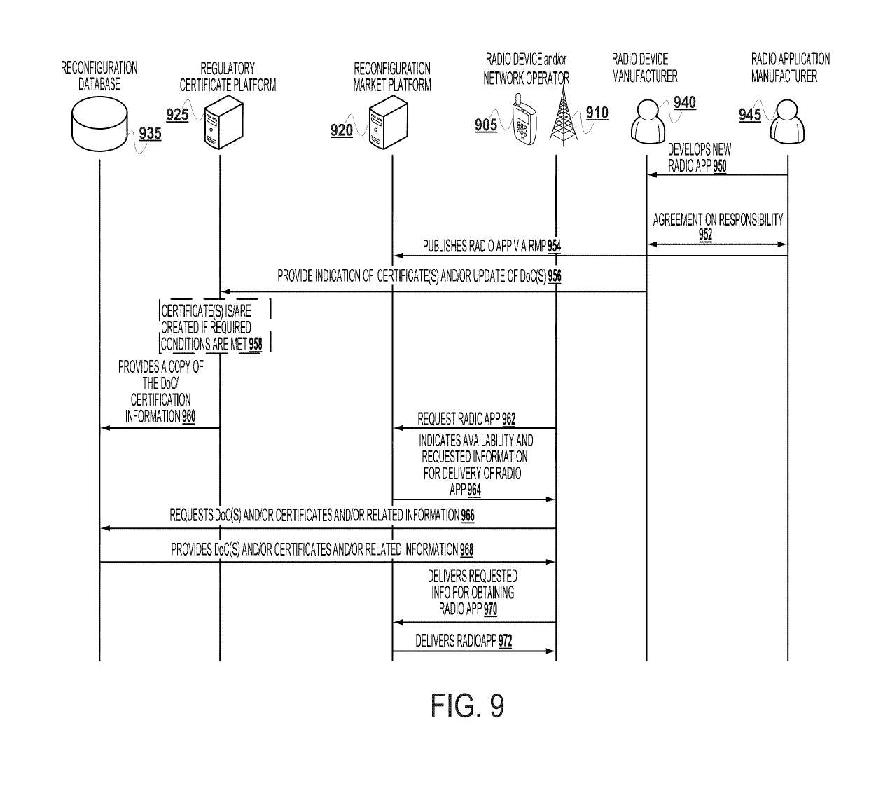

As shown in FIG. 9, a sequence diagram illustrates systems and operations associated with storage and provision of information associated with a DoC at a reconfiguration database 935, in accordance with various embodiments. According to various embodiments, the radio device 905 may be an embodiment of the radio device 205, the RMP 920 may be an embodiment of the RMP 220, the RCP 925 may be an embodiment of the RCP 225, and/or the reconfiguration database 335 may be an embodiment of the reconfiguration database 235, as illustrated in FIG. 2. The network operator 910 may operate the base station 210 of FIG. 2.

In some embodiments, the reconfiguration database 935 may be collocated with the RCP 925, for example, the reconfiguration database 935 and the RCP 925 may be part of a same system (e.g., a server system, a same cloud center, a same data center). In other embodiments, the reconfiguration database 935 may be remotely located from the RCP 925 and may be coupled thereto over a network.

In some embodiments, the RCP 925 may be operated by operated by the NRA, another similar organization (e.g., the FCC, the CEPT, or the like), and/or a third party with a mandate from a similar regulatory entity. As such, the RCP 925 may function as a “knowledge center.” However, information associated with DoCs may be stored, at least partially, at the reconfiguration database 935. Accordingly, individual requests on the availability of information associated with DoCs may be directed to the reconfiguration database 935, for example, by the RCP 925.

An embodiment of this approach to the management and/or storage of DoC-associated information may be the sequence of FIG. 9, beginning with operation 950. At operation 950, the manufacturer 945 of a radio application develops a new radio application that is to alter the radio characteristics of the radio device 905. The radio application manufacturer 945 may communicate with a manufacturer 940 of the radio device 905, for example, to ensure compatibility with the radio device 905. At operation 952, the radio application manufacturer 945 and the radio device manufacturer 940 may communicate to reach an agreement on the entity responsible for providing information associated with a DoC that indicates the radio device 905 is authorized to operate the radio application to alter one or more radio characteristics.

At operation 954, the radio application manufacturer 945 may transmit the radio application to the RMP 920. Thus, the RMP 920 may be able to provide the radio application to the radio device 905 after verification that the radio device 905 is authorized to operate the radio application.

At operation 956, the radio device manufacturer 940 may transmit, to the RCP 925, an indication to store DoC-associated information so that the radio application may be authorized for operation by the radio device 905. In one embodiment, the radio device manufacturer 940 may transmit an indication that a resource that is referenced by DoC-associated information is to be updated. In another embodiment, the radio device manufacturer 940 may transmit, to the RCP 925, an indication of a certificate that indicates the radio application is to be authorized according to existing DoC-associated information (e.g., a DoC accessible at the radio device 905).

In one embodiment, the radio device manufacturer 940 may transmit the DoC-associated information, such as the certificate and/or the resource (e.g., text file or other electronic document). In another embodiment, the radio device manufacturer 640 may transmit a request that the RCP 625 create the DoC-associated information. Accordingly, the RCP 958 may create the DoC-associated information based on the indication provided by the radio device manufacturer. For example, the RCP 925 may create a certificate associated with a DoC accessible at the radio device 905 and/or update a resource referenced by a DoC accessible at the radio device 905.

At operation 958, the RCP 925 may provide the DoC-associated information to the reconfiguration database 935. In various embodiments, the RCP 925 may provide a duplicate of the DoC-associated information so that the DoC-associated information is redundantly stored. The RCP 925 may further provide other information (e.g., certification information), such as a valid duration, an availability status, and the like. In one embodiment, the RCP 925 may be adapted to delete DoC-associated information stored at the reconfiguration database 935.

In one embodiment, DoC-associated information for radio application authorization for the radio device 905 may be accessed at the reconfiguration database 935 so that the RCP 925 is bypassed for the retrieval of the DoC-associated information.

At operation 960, the radio device 905 may transmit a request associated with the radio application to the RMP 920. In response to the request, the RMP 920 may determine the availability and/or information that is to be provided by the radio device 905 in order for the requested radio application to be provided. If the radio application is not available, the RMP 920 may indicate the unavailability to the radio device 905, as shown at operation 962. Alternatively, the RMP 920 may transmit an indication of the information that is to be provided to the RMP 920 in order to verify that the radio device 905 is authorized to operate the radio application.

Based on the response from the RMP 920, the radio device 905 may transmit a request to the reconfiguration database 935 to retrieve the requisite DoC-associated information associated with authorization of the radio application, as illustrated at operation 964. At operation 966, the reconfiguration database 935 identifies any DoC-associated information based on the request and, if any DoC-associated information is identified, transmits the identified DoC-associated information to the radio device 905.

At operation 968, the radio device 905 may transmit the information, indicated by the RMP 920 as required for provision of the radio application, received from the reconfiguration database 935. In response, the RMP 920 may determine if the information provided by the radio device 905 indicates that the radio device 905 is authorized to operate the requested radio application.

At operation 970, the RMP 920 may transmit the radio application together with an indication of any operational parameters applicable to operation of the radio application to the radio device 905 if the radio device 905 is authorized to operate the radio application. The radio device 905 may then operate the radio application to alter one or more of the radio characteristics of the radio device 905, taking into account the operational parameters associated with operation of the radio application from the RMP 920.

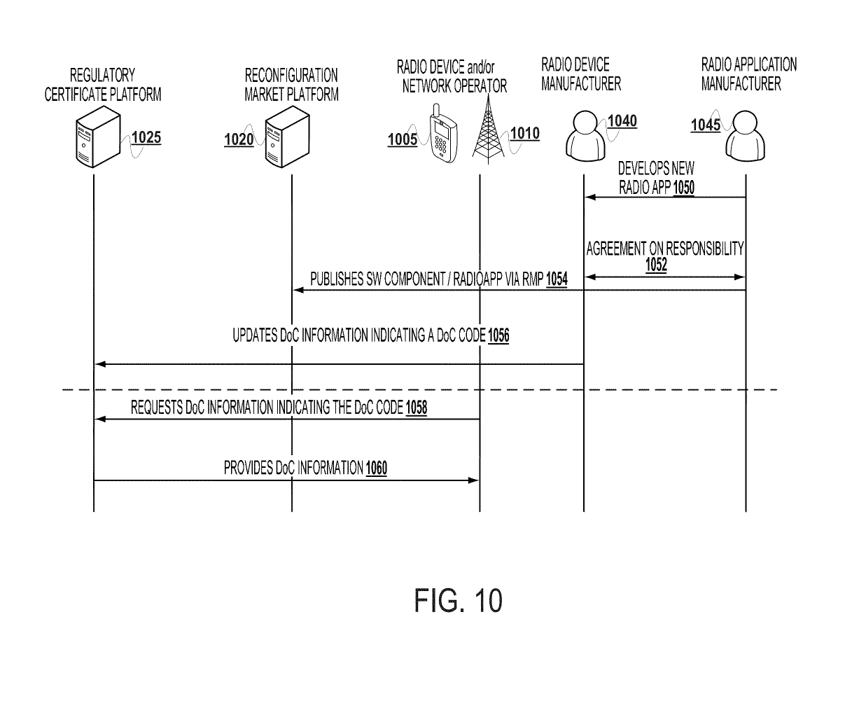

Now with reference to FIG. 10, a sequence diagram illustrates systems and operations associated with accessing a resource for information associated with a DoC, in accordance with various embodiments. According to various embodiments, the radio device 1005 may be an embodiment of the radio device 205, the RMP 1020 may be an embodiment of the RMP 220, and/or the RCP 1025 may be an embodiment of the RCP 225, as illustrated in FIG. 2. The network operator 1010 may operate the base station 210 of FIG. 2.

In some embodiments, a DoC provided with the radio device 1005 may include a URI or other pointer that references a resource at which actual and currently valid DoC-associated information is indicated. In some embodiments, the resource may be hosted at the RCP 1025 and/or a reconfiguration database (not shown). In some embodiments, a DoC provided with the radio device 1005 may include a code (e.g., a value or other identifier). The radio device 1005 may use this code when contacting a system at DoC-associated information is hosted (e.g., the RCP 1025 and/or a reconfiguration database).

An embodiment of this approach to DoC management may be the sequence of FIG. 10, beginning with operation 1050. At operation 1050, the manufacturer 1045 of a radio application develops a new radio application that is to alter the radio characteristics of the radio device 1005. The radio application manufacturer 1045 may communicate with a manufacturer 1040 of the radio device 1005, for example, to ensure compatibility with the radio device 1005. At operation 1052, the radio application manufacturer 1045 and the radio device manufacturer 1040 may communicate to reach an agreement on the entity responsible for providing information associated with a DoC that indicates the radio device 1005 is authorized to operate the radio application to alter one or more radio characteristics.

At operation 1054, the radio application manufacturer 1045 may transmit the radio application to the RMP 1020. Thus, the RMP 1020 may be able to provide the radio application to the radio device 1005 after verification that the radio device 1005 is authorized to operate the radio application.

At operation 1056, the radio device manufacturer 1040 may transmit, to the RCP 1025, an indication to store DoC-associated information so that the radio application may be authorized for operation on the radio device 1005. In one embodiment, the radio device manufacturer 1040 may transmit an indication that a resource that is referenced by DoC-associated information is to be updated and the radio device manufacturer 1040 may indicate that resource based on a DoC code applicable to a DoC accessible at the radio device 1005.

Thereafter, the radio device 1005 may request DoC-associated information by indicating to the RCP 1025 the code associated with the DoC accessible at the radio device 1005, as illustrated at operation 1058. At operation 1060, the RCP 1025 may identify a resource that corresponds to the DoC code and provide information from that resource to the radio device 1005 in response.

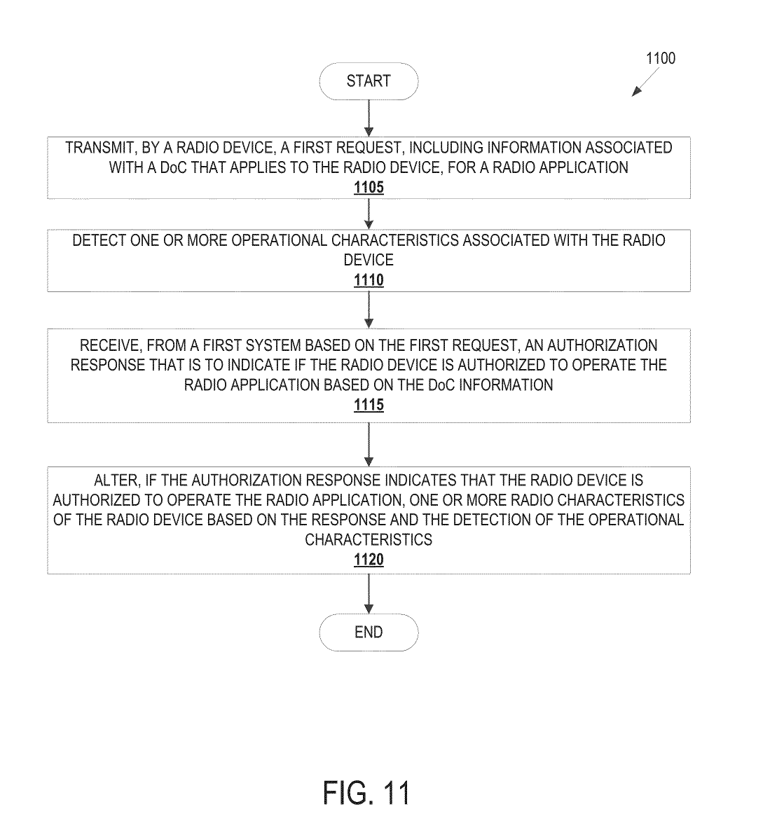

With respect to FIG. 11, a flow diagram illustrates a method 1100 for requesting a radio application for operation by a radio device, in accordance with various embodiments. The method 900 may be performed by a radio device, such as the radio device 205 of FIG. 2. While FIG. 11 illustrates a plurality of sequential operations, one of ordinary skill would understand that one or more operations of the method 1100 may be transposed and/or performed contemporaneously.

To begin, the method 1100 may include operation 1105 for transmitting, by a radio device, a first request for a radio application. The first request may be wirelessly transmitted from the radio device to a first system that is associated with the provision of radio applications. The first request may include information associated with a DoC that applies to the radio device. In one embodiment, this DoC-associated information may include a current DoC accessible at the radio device. In one embodiment, this DoC-associated information may be obtained from an external resource accessed by the radio device based on the DoC at the radio device. In one embodiment, this DoC-associated information may include an indication of one or more certificates stored in the radio device. In some embodiments, this request may include an indication of the type of radio device and/or an identifier associated with the radio device (e.g., a code, number, or identifier value). In some embodiments, the data included in the request may support a search for additional DoC-associated information.

The method 1100 may further include operation 1110 for detecting one or more operational characteristics associated with the radio device. In various embodiments, the operational characteristics may include one or more of a geographic area associated with the radio device, a current time, a frequency associated with communication by the radio device, or another radio application stored in the radio device.

Operation 1115 may comprise receiving, from the first system based on the first request, an authorization response that is to indicate if the radio device is authorized to operate the radio application based on the DoC-associated information. In one embodiment, the response is an indication that the radio device is not authorized to operate the radio application. In another embodiment, the response comprises the radio application and operational parameters associated with operation of the radio application by the radio device.

According to some embodiments, the radio device may facilitate the authorization operations associated with the first system. In such embodiments, the radio device may receive, from the first system, a request for additional DoC-associated information (e.g., a certificate). Based on the received request, the radio device may transmit a request to a second system that is associated with the regulation of radio applications for the additional DoC-associated information (e.g., the certificate). The radio device may receive, from the second system, the additional DoC-associated information (e.g., the certificate). Subsequently, the radio device may transmit this additional DoC-associated information (e.g., the certificate) to the first system to facilitate a determination by the first system that the radio device is authorized to operate the radio application.

If the authorization response indicates that the radio device is authorized to operate the radio application (e.g., the authorization response includes the radio device and operational parameters), operation 1120 may include altering one or more radio characteristics of the radio device based on the response (e.g., based on the radio application and/or the operational parameters) and the detection of the operational characteristics (e.g., ensuring and/or altering the operational characteristics to be consistent and/or comply with the operational parameters).

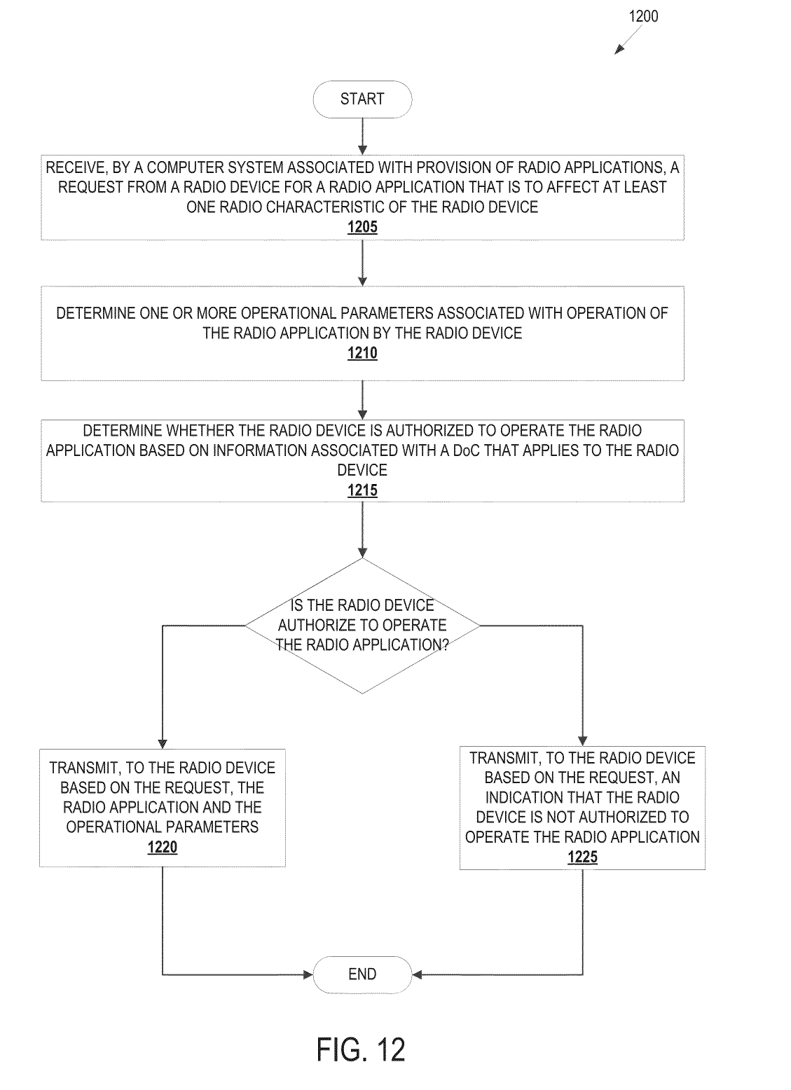

With respect to FIG. 12, a flow diagram illustrates a method 1200 for providing a radio application to a radio device by a computer system, in accordance with various embodiments. The method 1200 may be performed by an RMP, such as the RMP 220 of FIG. 2. While FIG. 12 illustrates a plurality of sequential operations, one of ordinary skill would understand that one or more operations of the method 1200 may be transposed and/or performed contemporaneously.

Beginning with operation 1205, the method 1200 may include receiving, over a wireless network, a request from a radio device for a radio application that is to affect at least one radio characteristic of the radio device. In various embodiments, this request may include information associated with a DoC that applies to the radio device. In one embodiment, this DoC-associated information may include a current DoC accessible at the radio device. In one embodiment, this DoC-associated information may include an indication of one or more certificates stored in the radio device. In some embodiments, this request may include an indication of the type of radio device and/or an identifier associated with the radio device (e.g., a code, number, or identifier value). In some embodiments, the data included in the request may support a search for additional DoC-associated information.

Operation 1210 may comprise determining one or more operational parameters associated with operation of the radio application by the radio device. In various embodiments, one or more operational parameters may be stored at the system performing the method 1200. In various embodiments, the one or more operational parameters may be obtained from a database associated with provision of operational parameters.

Operation 1215 may include determining whether the radio device is authorized to operate the radio application based on information associated with a DoC that applies to the radio device. In some embodiments, operation 1215 may include operations associated with obtaining DoC-associated information (e.g., a certificate) from another computer system associated with regulation of radio application (e.g., an RCP). In such embodiments, the computer system may transmit, to the other computer system, a request for that DoC-associated information (e.g., certificate). This transmitted request may include the data from the received request. Based on the transmitted request, the DoC-associated information (e.g., certificate) may be received from the other computer system.

In some embodiments, operation 1215 may be facilitated by the radio device. In such embodiments, the computer system may determine additional DoC-associated information that is to be provided by the radio device in order to determine that that radio application is authorized to operate the radio application. The computer system may transmit, to the radio device, an authorization request indicating the additional DoC-associated information that is to be provided. Based on the transmitted request, the computer system may receive the additional DoC-associated information. The computer system may then determine whether the radio device is authorized to operate the radio application.

If the determining at operation 1215 indicates that the radio device is authorized to operate the radio application, the method 1200 may reach operation 1220 for transmitting, to the radio device based on the request, the radio application and the operational parameters. Conversely, if the determining at operation 1215 indicates that the radio device is not authorized to operate the radio application, the method 1200 may reach operation 1225 for transmitting, to the radio device based on the request, an indication that the radio device is not authorized to operate the radio application.

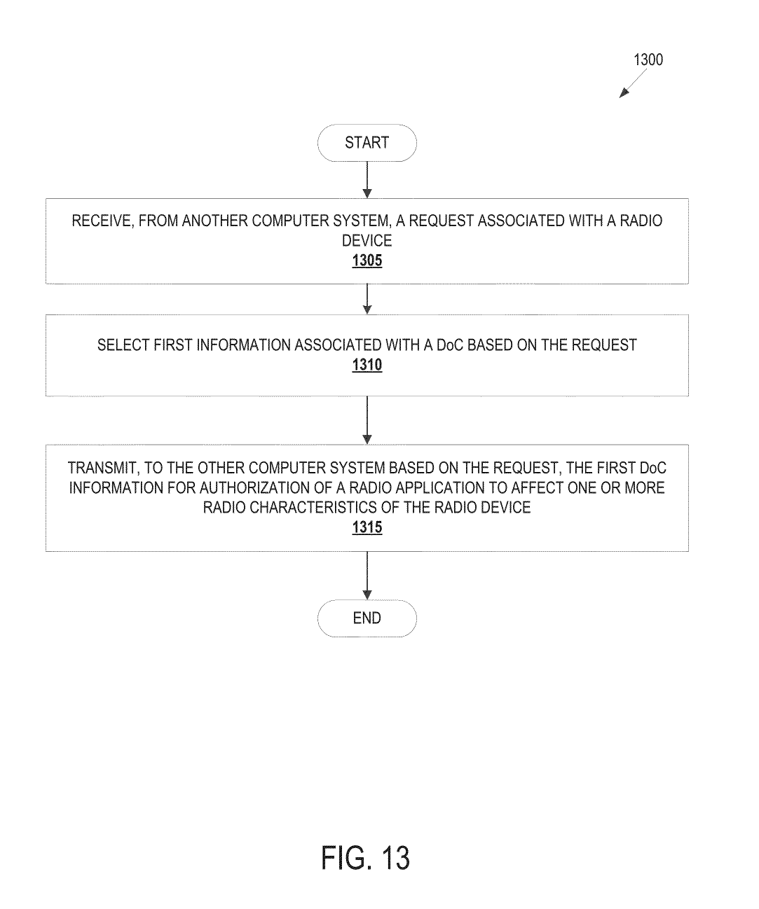

Turning to FIG. 13, a flow diagram illustrates a method 1300 for providing information associated with a DoC by a computer system for authorization of a radio application for a radio device, in accordance with various embodiments. The method 1300 may be performed by an RCP, such as the RCP 225 of FIG. 2. While FIG. 13 illustrates a plurality of sequential operations, one of ordinary skill would understand that one or more operations of the method 1300 may be transposed and/or performed contemporaneously.

Beginning with operation 1305, the method 1300 may include receiving, from another computer system, a request associated with a radio device. In various embodiments, this request may be received from a radio device or another computer system that is associated with provision of radio applications (e.g., an RMP). The request may comprise information that supports a search for DoC-associated information. In various embodiments, the request may comprise a current DoC accessible at the radio device. In one embodiment, this DoC-associated information may include an indication of one or more certificates stored in the radio device. In some embodiments, this request may include an indication of the type of radio device and/or an identifier associated with the radio device (e.g., a code, number, or identifier value). In some embodiments, this request may comprise information associated with the radio application, such as an identifier associated with the radio application.

Operation 1310 may include selecting first information associated with a DoC based on the received request. In one embodiment, operation 1310 includes selecting a certificate associated with a DoC that applies to the radio device and/or the radio application. In various embodiments, this operation 1310 may include operations associated with searching for the first DoC-associated information using data from the received request.

Thereafter, operation 1315 may include transmitting, to the other computer system (e.g., the radio device or the RMP), the first DoC-associated information. This first DoC-associated information may facilitate authorization of the radio application to affect one or more radio characteristics of the radio device.

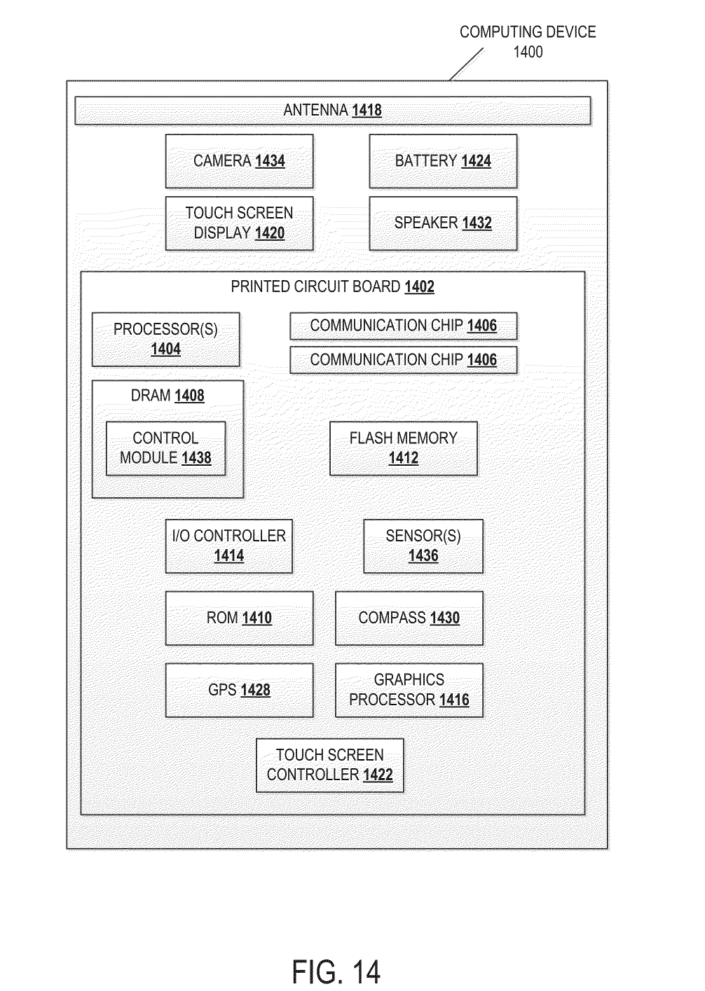

Now with reference to FIG. 14, a block diagram illustrates an example computing device 1400, in accordance with various embodiments. One or more of the radio device 205, the RMP 220, the RCP 225, the operational database 230, and/or the reconfiguration database 235 of FIG. 2 and described herein may be implemented on a computing device such as computing device 1400. Further, the computing device 1400 may be adapted to perform one or more operations of the method 1100 described with respect to FIG. 11, the method 1200 described with respect to FIG. 12, and/or the method 1300 described with respect to FIG. 13. The computing device 1400 may include a number of components, one or more processors 1404, and one or more communication chips 1406. Depending upon the embodiment, one or more of the enumerated components may comprise “circuitry” of the computing device 1400, such as processing circuitry, communication circuitry (e.g., transmitter and/or receiver circuitry), storage circuitry, and the like. In various embodiments, the one or more processor(s) 1404 each may be a processor core. In various embodiments, the one or more communication chips 1406 may be physically and electrically coupled with the one or more processor(s) 1404. In further implementations, the communication chips 1406 may be part of the one or more processor(s) 1404. In various embodiments, the computing device 1400 may include a printed circuit board (“PCB”) 1402. For these embodiments, the one or more processor(s) 1404 and communication chip 1406 may be disposed thereon. In alternate embodiments, the various components may be coupled without the employment of the PCB 1402.

Depending upon its applications, the computing device 1400 may include other components that may or may not be physically and electrically coupled with the PCB 1402. These other components include, but are not limited to, volatile memory (e.g., dynamic random access memory 1408, also referred to as “DRAM”), non-volatile memory (e.g., read only memory 1410, also referred to as “ROM”), flash memory 1412, an input/output controller 1414, a digital signal processor (not shown), a crypto processor (not shown), a graphics processor 1416, one or more antenna(s) 1418, a display (not shown), a touch screen display 1420, a touch screen controller 1422, a battery 1424, an audio codec (not shown), a video code (not shown), a global navigation satellite system 1428, a compass 1430, an accelerometer (not shown), a gyroscope (not shown), a speaker 1432, a camera 1434, one or more sensors 1436 (e.g., a barometer, Geiger counter, thermometer, viscometer, rheometer, altimeter, or other sensor that may be found in various manufacturing environments or used in other applications), a mass storage device (e.g., a hard disk drive, a solid state drive, compact disk and drive, digital versatile disk and drive, etc.) (not shown), and the like. In various embodiments, the one or more processor(s) 1404 may be integrated on the same die with other components to form a system on a chip (“SOC”).

In various embodiments, volatile memory (e.g., DRAM 1408), non-volatile memory (e.g., ROM 1410), flash memory 1412, and the mass storage device (not shown) may include programming instructions configured to enable the computing device 1400, in response to the execution by one or more processor(s) 1404, to practice all or selected aspects of the data exchanges and methods described herein, depending on the embodiment of the computing device 1400 used to implement such data exchanges and methods. More specifically, one or more of the memory components (e.g., DRAM 1408, ROM 1410, flash memory 1412, and the mass storage device) may include temporal and/or persistent copies of instructions that, when executed by one or more processor(s) 1404, enable the computing device 1400 to operate one or more modules 1438 configured to practice all or selected aspects of the data exchanges and method described herein, depending on the embodiment of the computing device 1400 used to implement such data exchanges and methods.

The communication chips 1406 may enable wired and/or wireless communication for the transfer of data to and from the computing device 1400. The term “wireless” and its derivatives may be used to describe circuits, devices, systems, methods, techniques, communication channels, etc., that may communicate data through the use of modulated electromagnetic radiation through a non-solid medium. The term does not imply that the associated devices do not contain any wires, although in some embodiments they might not. The communication chips 1406 may implement any of a number of wireless standards or protocols, including but not limited to LTE, LTE-A, Institute of Electrical and Electronics Engineers (“IEEE”) 702.20, General Packet Radio Service (“GPRS”), Evolution Data Optimized (“Ev-DO”), Evolved High Speed Packet Access (“HSPA+”), Evolved High Speed Downlink Packet Access (“HSDPA+”), Evolved High Speed Uplink Packet Access (“HSUPA+”), Global System for Mobile Communications (“GSM”), Enhanced Data Rates for GSM Evolution (“EDGE”), Code Division Multiple Access (“CDMA”), Time Division Multiple Access (“TDMA”), Digital Enhanced Cordless Telecommunications (“DECT”), Bluetooth, derivatives thereof, as well as other wireless protocols that are designated as 3G, 4G, 5G, and beyond. The computing device 1400 may include a plurality of communication chips 1406 adapted to perform different communication functions. For example, a first communication chip 1406 may be dedicated to shorter range wireless communications, such as Wi-Fi and Bluetooth, whereas a second communication chip 1406 may be dedicated to longer range wireless communications, such as GPS, EDGE, GPRS, CDMA, WiMAX, LTE, LTE-A, Ev-DO, and the like.

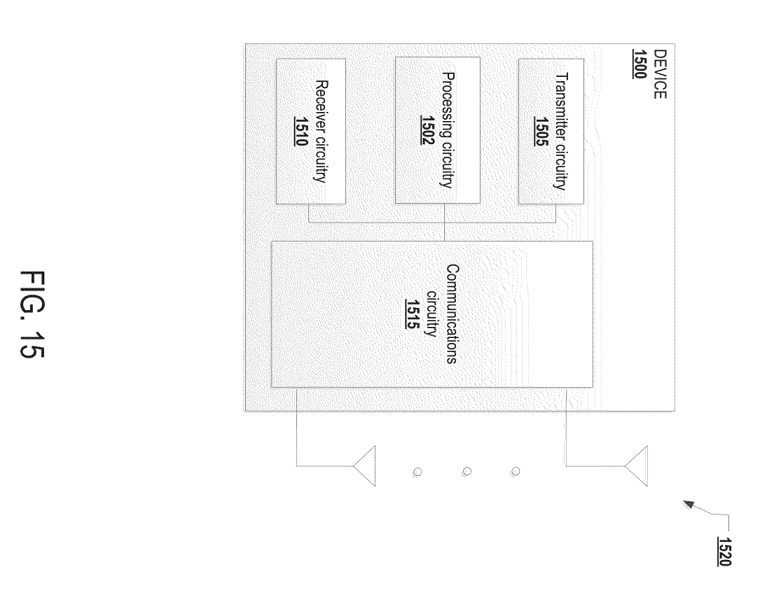

FIG. 15 illustrates a device 1500 in accordance with some embodiments. The device 1500 may be similar to and/or included in the radio device 205 of FIG. 2. The device 1500 may include processing circuitry 1502, transmitter circuitry 1505, receiver circuitry 1510, communications circuitry 1515, and one or more antennas 1520 coupled with each other at least as shown.

Briefly, the communications circuitry 1515 may be coupled with the antennas 1520 to facilitate over-the-air communication of signals to/from the device 1500. Operations of the communications circuitry 1515 may include, but are not limited to, filtering, amplifying, storing, modulating, demodulating, transforming, etc.

The transmitter circuitry 1505 may be coupled with the communications circuitry 1515 and may be configured to provide signals to the communications circuitry 1515 for transmission by the antennas 1520. In various embodiments, the transmitter circuitry 1505 may be configured to provide various signal processing operations on the signal to provide the signal to the communications circuitry 1515 with appropriate characteristics. In some embodiments, the transmitter circuitry 1505 may be adapted to generate signals. Further, the transmitter circuitry 1505 may be adapted to scramble, multiplex, and/or modulate various signals prior to transmission by the communications circuitry 1515.

The receiver circuitry 1510 may be coupled with the communications circuitry 1515 and may be configured to receive signals from the communications circuitry 1515. In some embodiments, the receiver circuitry 1510 may be adapted to generate signals. Further, the receiver circuitry 1510 may be adapted to descramble, de-multiplex, and/or demodulate various signals following reception by the communications circuitry 1515.

The processing circuitry 1502 may be coupled with the transmitter circuitry 1505, the receiver circuitry 1510, and/or the communications circuitry 1515. The processing circuitry may be adapted to perform operations described herein with respect to a radio device. In some embodiments, the processing circuitry 1502 may be adapted to generate, process, and/or manipulate data that is to be transmitted over the air, e.g., to and/or from a base station and/or a radio device.

Some or all of the communications circuitry 1515, transmitter circuitry 1505, and/or receiver circuitry 1510 may be included in, for example, a communication chip and/or communicatively coupled with a printed circuit board as described with respect to FIG. 14.

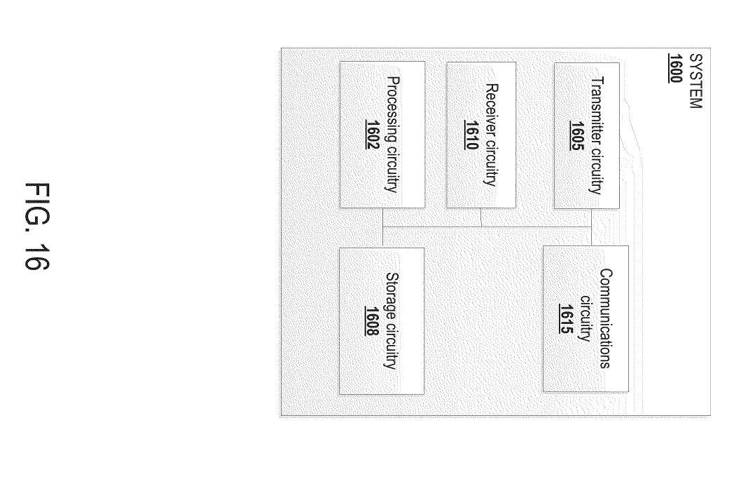

FIG. 16 illustrates a system 1600 in accordance with some embodiments. The system 1600 may be similar to and/or included in the RMP 220, the RCP 225, the operational database 230, and/or the reconfiguration database 235 of FIG. 2. The device 1600 may include processing circuitry 1602, transmitter circuitry 1605, receiver circuitry 1610, and/or communications circuitry 1615, coupled with each other at least as shown.

Briefly, the communications circuitry 1615 may comprise a network interface to facilitate communication of signals to/from the system 1600. Operations of the communications circuitry 1615 may include, but are not limited to, filtering, amplifying, storing, modulating, demodulating, transforming, etc. In various embodiments, the communications circuitry 1615 may comprise a plurality of different circuitries (e.g., radios, host bus adapters, etc.).

The transmitter circuitry 1605 may be coupled with the communications circuitry 1615 and may be configured to provide signals to the communications circuitry 1615 for communication over a network. In various embodiments, the transmitter circuitry 1605 may be configured to provide various signal processing operations on the signal to provide the signal to the communications circuitry 1615 with appropriate characteristics. In some embodiments, the transmitter circuitry 1605 may be adapted to generate signals. Further, the transmitter circuitry 1605 may be adapted to scramble, multiplex, and/or modulate various signals prior to transmission by the communications circuitry 1615.

The receiver circuitry 1610 may be coupled with the communications circuitry 1615 and may be configured to receive signals from the communications circuitry 1615. In some embodiments, the receiver circuitry 1610 may be adapted to generate signals. Further, the receiver circuitry 1610 may be adapted to descramble, de-multiplex, and/or demodulate various signals following reception by the communications circuitry 1615.

The processing circuitry 1602 may be coupled with the transmitter circuitry 1605, the receiver circuitry 1610, and/or the communications circuitry 1615. The processing circuitry may be adapted to perform operations described herein with respect to an RMP, RCP, operational database, and/or reconfiguration database. In some embodiments, the processing circuitry 1602 may be adapted to generate, process, and/or manipulate data that is to be transmitted over a network. In particular, the processing circuitry 1602 may be adapted to perform operations associated with determining information associated with authorization of a radio application for operation by a radio device.

The storage circuitry 1608 may comprise circuitry for storing data. In embodiments, the storage circuitry 1608 may comprise one or more of volatile memory (e.g., DRAM) or non-volatile memory (e.g., programmable read only memory, erasable programmable read only memory, electrically erasable programmable read only memory), and/or flash memory (e.g., floating gate memory, charge tramping memory, magnetoresistive random access memory, and/or phase change random access memory).

Some or all of the communications circuitry 1615, transmitter circuitry 1605, and/or receiver circuitry 1610 may be included in, for example, a communication chip and/or communicatively coupled with a printed circuit board as described with respect to FIG. 14.

In various embodiments, example 1 may be an apparatus to be included in a radio device, the apparatus comprising: transmitter circuitry to transmit, to a first system associated with provision of radio applications, a first request, including information associated with a declaration of conformity (“DoC”) that applies to the radio device, for a radio application; receiver circuitry to receive, from the first system based on the first request, an authorization response that is to indicate whether the radio device is authorized to operate the radio application based on the information associated with the DoC; and processing circuitry, coupled with the transmitter circuitry and the receiver circuitry, to detect one or more operational characteristics associated with the radio device, and, if the authorization response indicates that the radio device is authorized to operate the radio application, alter one or more radio characteristics of the radio device based on the response and the detection of the operational characteristics. Example 2 may include the apparatus of example 1, wherein the processing circuitry is to access an external resource to determine the DoC-associated information based on the DoC. Example 3 may include the apparatus of example 1, wherein the DoC-associated information comprises at least one of a certificate that is to supplement the DoC that applies to the radio device or a version of the DoC. Example 4 may include the apparatus of example 1, wherein the one or more operational characteristics associated with the radio device include one or more of a geographic area associated with the radio device, a current time, a frequency associated with communication by the radio device, or another radio application stored in the radio device. Example 5 may include the apparatus of example 1, wherein the receiver circuitry is to receive an indication of one or more operational parameters, and further wherein the processing circuitry is to alter the one or more radio characteristics based on comparison of the operational parameters to the operational characteristics. Example 6 may include the apparatus of example 5, wherein the one or more operational parameters include one or more of a geographic limitation for usage of the radio application, a time limitation for usage of the radio application, a frequency limitation for usage of the radio application, an output power level, or a spectrum sharing constraint. Example 7 may include the apparatus of example 5, wherein the processing circuitry is to generate a parameters request for the operational parameters, and further wherein the transmitter circuitry is to transmit the parameters request to a database that is associated with the provision of operational parameters. Example 8 may include the apparatus of any of examples 1-7, wherein the processing circuitry is to generate the first request to further include at least one of a type of the radio device or an identifier associated with the radio device. Example 9 may include the apparatus of any of examples 1-7, wherein the authorization response includes one of the radio application or an indication that the radio device is not authorized to operate the radio application. Example 10 may include the apparatus of any of examples 1-7, wherein the transmitter circuitry is further to transmit, to the first system, a certificate based on a request received from the first system, and to transmit, to a second system associated with regulation of radio applications, a second request for the certificate, and further wherein the receiver circuitry is further to receive, based on the transmitted first request, the request from the first system before the authorization response, and to receive, from the second system, the certificate based on the transmitted second request. Example 11 may include the apparatus of example 10, wherein the second request for the certificate is to include at least one of a current geographic location associated with the radio device, a usage interval associated with the radio application, or a target frequency band associated with communication by the radio device. Example 12 may include the apparatus of any of examples 1-7, wherein the receiver circuitry is to receive a validation request, from a second system that is associated with regulation of radio applications, for additional information associated with the DoC, and further wherein the transmitter circuitry is to transmit the additional DoC-associated information to the second system based on the validation request. Example 13 may include the apparatus of example 12, wherein the receiver circuitry is to receive, based on the additional DoC-associated information transmitted to the second system, a notification that the radio device is not authorized to continue operation of the radio application, and further wherein the processing circuitry is to cease the operation of the radio application based on the notification.

In various embodiments, example 14 may be a computer system for providing radio applications to radio devices, the system comprising: receiver circuitry to receive, from a radio device, a request for a radio application that is to affect at least one radio characteristic of the radio device; processing circuitry, coupled with the receiver circuitry, to determine whether the radio device is authorized to operate the radio application based on information associated with a declaration of conformity (“DoC”) that applies to the radio device, and to determine one or more operational parameters associated with operation of the radio application by the radio device; and transmitter circuitry, coupled with the processing circuitry, to transmit, to the radio device based on the request, either the radio application and the operational parameters or an indication that the radio device is not authorized to operate the radio application based on the determination of whether the radio device is authorized to operate the radio application. Example 15 may include the computer system of example 14, wherein the determination of whether the radio device is authorized to operate the radio application based on the information associated with the DoC comprises to: transmit, by the transmitter circuitry, a request for the DoC-associated information to a second system that is associated with regulation of radio applications; receive, by the receiver circuitry, the DoC-associated information based on the request; and determine, by the processing circuitry, whether the radio device is authorized to operate the radio application based on the received DoC-associated information. Example 16 may include the computer system of example 14, wherein the determination of whether the radio device is authorized to operate the radio device based on the information associated with the DoC comprises to: transmit, by the transmitter circuitry, a request for authorization information associated with the DoC to the radio device based on the received request; receive, by the receiver circuitry, the authorization information based on the transmitted request; and determine, by the processing circuitry, whether the radio device is authorized to operate the radio application based on the received authorization information. Example 17 may include the computer system of example 16, wherein the information associated with the DoC comprises a first part included in the received request and the authorization information. Example 18 may include the computer system of any of examples 14-17, wherein the determination of the one or more operational parameters comprises to: transmit, by the transmitter circuitry, a request for the operational parameters to a computer system having an operational database; and receive, by the receiver circuitry, an indication of the one or more operational parameters from the computer system having the operational database. Example 19 may include the computer system of any of examples 14-17, wherein the one or more operational parameters comprise one or more of an output power level, an available frequency band, or an operator preference.

In various embodiments, example 20 may be a computer system for regulating radio applications for radio devices, the system comprising: receiver circuitry to receive, from another computer system, a request associated with a radio device; processing circuitry, coupled with the receiver circuitry, to select first information associated with a first Declaration of Conformity (“DoC”) that applies to the radio device based on the request; and transmitter circuitry, coupled with the processing circuitry, to transmit the first DoC-associated information to the other computer system for authorization of a radio application to affect one or more radio characteristics of the radio device. Example 21 may include the computer system of example 20, wherein the request associated with the radio device is to include at least one of a current geographic location associated with the radio device, a usage interval associated with usage of the radio application by the radio device, or a target frequency band associated with communication by the radio device. Example 22 may include the computer system of example 20, wherein the other computer system is one of the radio device or a computer system associated with provision of the radio application to the radio device. Example 23 may include the computer system of any of examples 20-22, wherein the receiver circuitry is to receive an indication that the radio application is authorized to alter one or more radio characteristics of the radio device according to the first DoC, and further wherein the processing circuitry is to update the first DoC-associated information based on the indication. Example 24 may include the computer system of any of examples 20-22, wherein the transmitter circuitry is to transmit, to the radio device, a request for second information associated with a second DoC that is available to the radio device and the receiver circuitry is to receive an indication of the second DoC-associated information from the radio device based on the request, and further wherein the processing circuitry is to determine that the radio device is authorized to continue operation of the radio application based on the second DoC-associated information. Example 25 may include the computer system of example 24, wherein the transmitter circuitry is to transmit an instruction to the radio device to cause the radio device to cease operation of the radio application if processing circuitry determines that the radio device is not authorized to continue the operation of the radio application.

In various embodiments, example 26 may be one or more non-transitory computer-readable media comprising computing device-executable instructions, wherein the instructions, in response to execution by a radio device, cause the radio device to: transmit, to a first system associated with provision of radio applications, a first request, including information associated with a declaration of conformity (“DoC”) that applies to the radio device, for a radio application; receive, from the first system based on the first request, an authorization response that is to indicate if radio device is authorized to operate the radio application based on the DoC-associated information; detect one or more operational characteristics associated with the radio device; and alter, if the authorization response indicates that the radio device is authorized to operate the radio application, one or more radio characteristics of the radio device based on the response and the detection of the operational characteristics. Example 27 may include the one or more non-transitory computer-readable media of example 26, wherein the processing circuitry is to access an external resource to determine the DoC-associated information based on the DoC. Example 28 may include the one or more non-transitory computer-readable media of example 26, wherein the DoC-associated information comprises at least one certificate that is to supplement the DoC that applies to the radio device. Example 29 may include the one or more non-transitory computer-readable media of example 26, wherein the instructions are further to cause the radio device to: receive an indication of one or more operational parameters; and alter the one or more radio characteristics based on comparison of the operational parameters to the operational characteristics. Example 30 may include the one or more non-transitory computer-readable media of any of examples 26-29, wherein the authorization response includes one of the radio application or an indication that the radio device is not authorized to operate the radio application. Example 31 may include the one or more non-transitory computer-readable media of any of examples 26-29, wherein the instructions are further to cause the radio device to: receive, based on the transmitted first request, a request associated with a certificate from the first system before the authorization response; transmit, to a second system associated with regulation of radio applications, a second request for the certificate; receive, from the second system, the certificate based on the transmitted second request; and transmit, to the first system, the certificate based on a request received from the first system. Example 32 may include the one or more non-transitory computer-readable media of any of examples 26-29, wherein the instructions are further to cause the radio device to: receive a validation request, from a second system that is associated with regulation of radio applications, for additional information associated with the DoC; transmit the additional DoC-associated information to the second system based on the validation request. Example 33 may include the one or more non-transitory computer-readable media of example 32, wherein the instructions are further to cause the radio device to: receive, based on the additional DoC-associated information transmitted to the second system, a notification that the radio device is not authorized to continue operation of the radio application; and cease the operation of the radio application based on the notification.

In various embodiments, example 34 may include a method to be performed by a radio device, the method comprising: transmitting, to a first system associated with provision of radio applications, a first request, including information associated with a declaration of conformity (“DoC”) that applies to the radio device, for a radio application; receiving, from the first system based on the first request, an authorization response that is to indicate if radio device is authorized to operate the radio application based on the DoC-associated information; detecting one or more operational characteristics associated with the radio device; and altering, if the authorization response indicates that the radio device is authorized to operate the radio application, one or more radio characteristics of the radio device based on the response and the detection of the operational characteristics. Example 35 may include the method of example 34, further comprising: accessing an external resource to determine the DoC-associated information based on the DoC. Example 36 may include the method of example 34, wherein the DoC-associated information comprises at least one certificate that is to supplement the DoC that applies to the radio device. Example 36 may include the method of example 34, further comprising: receiving an indication of one or more operational parameters; and altering the one or more radio characteristics based on comparison of the operational parameters to the operational characteristics. Example 38 may include the method of any of examples 34-37, wherein the authorization response includes one of the radio application or an indication that the radio device is not authorized to operate the radio application. Example 39 may include the method of any of examples 34-37, further comprising: receiving, based on the transmitted first request, a request associated with a certificate from the first system before the authorization response; transmitting, to a second system associated with regulation of radio applications, a second request for the certificate; receiving, from the second system, the certificate based on the transmitted second request; and transmitting, to the first system, the certificate based on a request received from the first system. Example 40 may include the method of any of examples 34-37, further comprising: receiving a validation request, from a second system that is associated with regulation of radio applications, for additional information associated with the DoC; transmitting the additional DoC-associated information to the second system based on the validation request; receiving, based on the additional DoC-associated information transmitted to the second system, a notification that the radio device is not authorized to continue operation of the radio application; and ceasing the operation of the radio application based on the notification.

In various embodiments, example 41 may be one or more non-transitory computer-readable media comprising computing device-executable instructions, wherein the instructions, in response to execution by a computer system, cause the computer system to: receive, from a radio device, a request for a radio application that is to affect at least one radio characteristic of the radio device; determine whether the radio device is authorized to operate the radio application based on information associated with a declaration of conformity (“DoC”) that applies to the radio device; determine one or more operational parameters associated with operation of the radio application by the radio device; and transmit, to the radio device based on the request, either the radio application and the operational parameters or an indication that the radio device is not authorized to operate the radio application based on the determination of whether the radio device is authorized to operate the radio application. Example 42 may include the one or more non-transitory computer-readable media of example 41, wherein the determination of whether the radio device is authorized to operate the radio application based on the information associated with the DoC comprises to: transmit a request for the DoC-associated information to a second system that is associated with regulation of radio applications; receive the DoC-associated information based on the request; and determine whether the radio device is authorized to operate the radio application based on the received DoC-associated information. Example 43 may include the one or more non-transitory computer-readable media of example 41, wherein the determination of whether the radio device is authorized to operate the radio device based on the information associated with the DoC comprises to: transmit a request for authorization information associated with the DoC to the radio device based on the received request; receive the authorization information based on the transmitted request; and determine whether the radio device is authorized to operate the radio application based on the received authorization information. Example 44 may include the one or more non-transitory computer-readable media of example 43, wherein the information associated with the DoC comprises a first part included in the received request and the authorization information. Example 45 may include the one or more non-transitory computer-readable media of any of examples 41-44, wherein the determination of the one or more operational parameters comprises to: transmit, by the transmitter circuitry, a request for the operational parameters to a computer system having an operational database; and receive, by the receiver circuitry, an indication of the one or more operational parameters from the computer system having the operational database. Example 46 may include the one or more non-transitory computer-readable media of any of examples 41-44, wherein the one or more operational parameters comprise one or more of an output power level, an available frequency band, or an operator preference.

In various embodiments, example 47 may include a method to be performed by a computer system, the method comprising: receiving, from a radio device, a request for a radio application that is to affect at least one radio characteristic of the radio device; determining whether the radio device is authorized to operate the radio application based on information associated with a declaration of conformity (“DoC”) that applies to the radio device; determining one or more operational parameters associated with operation of the radio application by the radio device; and transmitting, to the radio device based on the request, either the radio application and the operational parameters or an indication that the radio device is not authorized to operate the radio application based on the determining of whether the radio device is authorized to operate the radio application. Example 48 may include the method of example 47, wherein the determining of whether the radio device is authorized to operate the radio application based on the information associated with the DoC comprises: transmitting a request for the DoC-associated information to a second system that is associated with regulation of radio applications; receiving the DoC-associated information based on the request; and determining whether the radio device is authorized to operate the radio application based on the received DoC-associated information. Example 49 may include the method of example 47, wherein the determining of whether the radio device is authorized to operate the radio device based on the information associated with the DoC comprises: transmitting a request for authorization information associated with the DoC to the radio device based on the received request; receiving the authorization information based on the transmitted request; and determining whether the radio device is authorized to operate the radio application based on the received authorization information. Example 50 may include the method of example 49, wherein the information associated with the DoC comprises a first part included in the received request and the authorization information. Example 51 may include the method of any of examples 47-50, wherein the determining of the one or more operational parameters comprises: transmitting, by the transmitter circuitry, a request for the operational parameters to a computer system having an operational database; and receiving, by the receiver circuitry, an indication of the one or more operational parameters from the computer system having the operational database. Example 52 may include the method of any of examples 47-50, wherein the one or more operational parameters comprise one or more of an output power level, an available frequency band, or an operator preference. Example 53 may include the one or more non-transitory computer-readable media comprising computing device-executable instructions, wherein the instructions, in response to execution by a computer system, cause the computer system to: receive, from another computer system, a request associated with a radio device; select first information associated with a first Declaration of Conformity (“DoC”) that applies to the radio device based on the request; and transmit the first DoC-associated information to the other computer system for authorization of a radio application to affect one or more radio characteristics of the radio device. Example 54 may include the one or more non-transitory computer-readable media of example 53, wherein the request associated with the radio device is to include at least one of a current geographic location associated with the radio device, a usage interval associated with usage of the radio application by the radio device, or a target frequency band associated with communication by the radio device. Example 55 may include the one or more non-transitory computer-readable media of example 53, wherein the other computer system is one of the radio device or a computer system associated with provision of the radio application to the radio device. Example 56 may include the one or more non-transitory computer-readable media of any of examples 53-55, wherein the instructions are further to cause the computing system to: receive an indication that the radio application is authorized to alter one or more radio characteristics of the radio device according to the first DoC; and update the first DoC-associated information based on the indication. Example 57 may include the one or more non-transitory computer-readable media of any of examples 53-55, wherein the instructions are further to cause the computing system to: transmit, to the radio device, a request for second information associated with a second DoC that is available to the radio device; receive an indication of the second DoC-associated information from the radio device based on the request; determine that the radio device is authorized to continue operation of the radio application based on the second DoC-associated information. Example 58 may include the one or more non-transitory computer-readable media of example 57, wherein the instructions are further to cause the computing system to: transmit an instruction to the radio device to cause the radio device to cease operation of the radio application based on a determination that the radio device is not authorized to continue the operation of the radio application.

In various embodiments, example 59 may include a method to be performed by a computer system, the method comprising: receiving, from another computer system, a request associated with a radio device; selecting first information associated with a first Declaration of Conformity (“DoC”) that applies to the radio device based on the request; and transmitting the first DoC-associated information to the other computing system for authorization of a radio application to affect one or more radio characteristics of the radio device. Example 60 may include the method of example 59, wherein the request associated with the radio device is to include at least one of a current geographic location associated with the radio device, a usage interval associated with usage of the radio application by the radio device, or a target frequency band associated with communication by the radio device. Example 61 may include the method of example 59, wherein the other computer system is one of the radio device or a computer system associated with provision of the radio application to the radio device. Example 62 may include the method of any of examples 59-61, further comprising: receiving an indication that the radio application is authorized to alter one or more radio characteristics of the radio device according to the first DoC; and updating the first DoC-associated information based on the indication. Example 63 may include the method of any of examples 59-61, further comprising: transmitting, to the radio device, a request for second information associated with a second DoC that is available to the radio device; receiving an indication of the second DoC-associated information from the radio device based on the request; determining that the radio device is authorized to continue operation of the radio application based on the second DoC-associated information. Example 64 may include the method of example 63, further comprising: transmitting an instruction to the radio device to cause the radio device to cease operation of the radio application based on determining that the radio device is not authorized to continue the operation of the radio application.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the arts. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

Embodiments of the invention also relate to an apparatus for performing the operations herein. Such a computer program is stored in a non-transitory computer-readable medium. A machine-readable medium includes any mechanism for storing information in a form readable by a machine (e.g., a computer). For example, a machine-readable (e.g., computer-readable) medium includes a machine- (e.g., a computer-) readable storage medium (e.g., read only memory (“ROM”), random access memory (“RAM”), magnetic disk storage media, optical storage media, flash memory devices).

The processes or methods depicted in the preceding figures can be performed by processing logic that comprises hardware (e.g., circuitry, dedicated logic, etc.), software (e.g., embodied on a non-transitory computer-readable medium), or a combination of both. Although the processes or methods are described above in terms of some sequential operations, it should be appreciated that some of the operations described can be performed in a different order. Moreover, some operations can be performed in parallel rather than sequentially.

Embodiments of the present invention are not described with reference to any particular programming language. It will be appreciated that a variety of programming languages can be used to implement the teachings of embodiments of the invention as described herein. In the foregoing Specification, embodiments of the invention have been described with reference to specific exemplary embodiments thereof. It will be evident that various modifications can be made thereto without departing from the broader spirit and scope of the invention as set forth in the following claims. The Specification and drawings are, accordingly, to be regarded in an illustrative sense rather than a restrictive sense.

What is claimed is:

1. An apparatus to be included in a radio device, the apparatus comprising:
transmitter circuitry to transmit, to a first system associated with provision of radio applications, a first request, including information associated with a declaration of conformity (“DoC”) that applies to the radio device, for a radio application;
receiver circuitry to receive, from the first system based on the first request, an authorization response that is to indicate whether the radio device is authorized to operate the radio application based on the information associated with the DOC; and
processing circuitry, coupled with the transmitter circuitry and the receiver circuitry, to detect one or more operational characteristics associated with the radio device, and, if the authorization response indicates that the radio device is authorized to operate the radio application, alter one or more radio characteristics of the radio device based on the response and the detection of the operational characteristics.

2. The apparatus of claim 1, wherein the processing circuitry is to access an external resource to determine the DoC-associated information based on the DoC.

3. The apparatus of claim 1, wherein the DoC-associated information comprises at least one of a certificate that is to supplement the DoC that applies to the radio device or a version of the DoC.

4. The apparatus of claim 1, wherein the one or more operational characteristics associated with the radio device include one or more of a geographic area associated with the radio device, a current time, a frequency associated with communication by the radio device, or another radio application stored in the radio device.

5. The apparatus of claim 1, wherein the receiver circuitry is to receive an indication of one or more operational parameters, and further wherein the processing circuitry is to alter the one or more radio characteristics based on comparison of the operational parameters to the operational characteristics.

6. The apparatus of claim 5, wherein the one or more operational parameters include one or more of a geographic limitation for usage of the radio application, a time limitation for usage of the radio application, a frequency limitation for usage of the radio application, an output power level, or a spectrum sharing constraint.

7. The apparatus of claim 5, wherein the processing circuitry is to generate a parameters request for the operational parameters, and further wherein the transmitter circuitry is to transmit the parameters request to a database that is associated with the provision of operational parameters.

8. The apparatus of claim 1, wherein the processing circuitry is to generate the first request to further include at least one of a type of the radio device or an identifier associated with the radio device.

9. The apparatus of claim 1, wherein the authorization response includes one of the radio application or an indication that the radio device is not authorized to operate the radio application.

10. The apparatus of claim 1, wherein the transmitter circuitry is further to transmit, to the first system, a certificate based on a request received from the first system, and to transmit, to a second system associated with regulation of radio applications, a second request for the certificate, and further wherein the receiver circuitry is further to receive, based on the transmitted first request, the request from the first system before the authorization response, and to receive, from the second system, the certificate based on the transmitted second request.

11. The apparatus of claim 10, wherein the second request for the certificate is to include at least one of a current geographic location associated with the radio device, a usage interval associated with the radio application, or a target frequency band associated with communication by the radio device.

12. The apparatus of claim 1, wherein the receiver circuitry is to receive a validation request, from a second system that is associated with regulation of radio applications, for additional information associated with the DoC, and further wherein the transmitter circuitry is to transmit the additional DoC-associated information to the second system based on the validation request.

13. The apparatus of claim 12, wherein the receiver circuitry is to receive, based on the additional DoC-associated information transmitted to the second system, a notification that the radio device is not authorized to continue operation of the radio application, and further wherein the processing circuitry is to cease the operation of the radio application based on the notification.

14. A computer system for providing radio applications to radio devices, the system comprising:
receiver circuitry to receive, from a radio device, a request for a radio application that is to affect at least one radio characteristic of the radio device;
processing circuitry, coupled with the receiver circuitry, to determine whether the radio device is authorized to operate the radio application based on information associated with a declaration of conformity (“DoC”) that applies to the radio device, and to determine one or more operational parameters associated with operation of the radio application by the radio device; and
transmitter circuitry, coupled with the processing circuitry, to transmit, to the radio device based on the request, either the radio application and the operational parameters or an indication that the radio device is not authorized to operate the radio application based on the determination of whether the radio device is authorized to operate the radio application.

15. The computer system of claim 14, wherein the determination of whether the radio device is authorized to operate the radio application based on the information associated with the DoC comprises to:
transmit, by the transmitter circuitry, a request for the DoC-associated information to a second system that is associated with regulation of radio applications;
receive, by the receiver circuitry, the DoC-associated information based on the request; and
determine, by the processing circuitry, whether the radio device is authorized to operate the radio application based on the received DoC-associated information.

16. The computer system of claim 14, wherein the determination of whether the radio device is authorized to operate the radio device based on the information associated with the DoC comprises to:
transmit, by the transmitter circuitry, a request for authorization information associated with the DoC to the radio device based on the received request;
receive, by the receiver circuitry, the authorization information based on the transmitted request; and
determine, by the processing circuitry, whether the radio device is authorized to operate the radio application based on the received authorization information.

17. The computer system of claim 16, wherein the information associated with the DoC comprises a first part included in the received request and the authorization information.

18. The computer system of claim 14, wherein the determination of the one or more operational parameters comprises to:
transmit, by the transmitter circuitry, a request for the operational parameters to a computer system having an operational database; and
receive, by the receiver circuitry, an indication of the one or more operational parameters from the computer system having the operational database.

19. The computer system of claim 14, wherein the one or more operational parameters comprise one or more of an output power level, an available frequency band, or an operator preference.

20. One or more non-transitory computer-readable media comprising computing device-executable instructions, wherein the instructions, in response to execution by a computer system, cause the computer system to:
receive, from another computer system, a request associated with a radio device;
select first information associated with a first Declaration of Conformity (“DoC”) that applies to the radio device based on the request; and
transmit the first DoC-associated information to the other computer system for authorization of a radio application to affect one or more radio characteristics of the radio device.

21. The one or more non-transitory computer-readable media of claim 20, wherein the request associated with the radio device is to include at least one of a current geographic location associated with the radio device, a usage interval associated with usage of the radio application by the radio device, or a target frequency band associated with communication by the radio device.

22. The one or more non-transitory computer-readable media of claim 20, wherein the other computer system is one of the radio device or a computer system associated with provision of the radio application to the radio device.

23. The one or more non-transitory computer-readable media of claim 20, wherein the instructions are further to cause the computing system to:
receive an indication that the radio application is authorized to alter one or more radio characteristics of the radio device according to the first DoC; and
update the first DoC-associated information based on the indication.

24. The one or more non-transitory computer-readable media of claim 20, wherein the instructions are further to cause the computing system to:
transmit, to the radio device, a request for second information associated with a second DoC that is available to the radio device;
receive an indication of the second DoC-associated information from the radio device based on the request;
determine that the radio device is authorized to continue operation of the radio application based on the second DoC-associated information.

25. The one or more non-transitory computer-readable media of claim 24, wherein the instructions are further to cause the computing system to:
transmit an instruction to the radio device to cause the radio device to cease operation of the radio application based on a determination that the radio device is not authorized to continue the operation of the radio application.
